(19) United States
(12) Patent Application Publication
(10) Pub. No.: US 2026/0291127 A1
(43) Pub. Date: Sep. 24, 2026

(54) MATING CONNECTOR HAVING LIMITING FEATURES TO LIMIT ROTATING COVER

(71) Applicant: Luxshare Automotive Connection System (Shanghai) Co., Ltd, Shanghai (CN)

(72) Inventors: Yaohui SHEN, Shanghai (CN); Haomai YIN, Shanghai (CN); Yaofeng DAI, Shanghai (CN); Aimin HU, Shanghai (CN)

(73) Assignee: Luxshare Automotive Connection System (Shanghai) Co., Ltd, Shanghai (CN)

(21) Appl. No.: 19/332,138

(22) Filed: Sep. 18, 2025

(30) Foreign Application Priority Data
Mar. 20, 2025 (CN) 202510336819.3

(51) Int. Cl. H01R 13/629

(52) U.S. Cl. CPC H01R 13/629; H01R 2201/26

(57) ABSTRACT

A mating connector includes a housing, a mating terminal, a locking device and a rotating cover. The housing includes a main body portion and an installation portion. The installation portion includes a protrusion. The mating terminal includes a mating portion. The locking device is installed on the main body portion along a first direction. The locking device includes a slider. The slider includes an elastic arm configured to engage with the protrusion along the first direction. The rotating cover is installed on the main body portion and configured to drive the mating terminal to move along a second direction. The rotating cover includes a slot, and the slider includes a tab that mates with the slot to limit the rotating cover.

### CROSS-REFERENCE TO RELATED APPLICATION

This patent application claims priority of a Chinese Patent Application No. 202510336819.3, filed on Mar. 20, 2025 and titled “MATING CONNECTOR”, the entire content of which is incorporated herein by reference.

### TECHNICAL FIELD

The present disclosure relates to a mating connector, which belongs to the field of connector technology.

### BACKGROUND

A connector assembly in related technologies normally includes an electrical connector and a mating connector configured to mate with the electrical connector. The electrical connector includes a first housing and at least one conductive terminal secured to the first housing. The mating connector includes a second housing and at least one mating conductive terminal secured to the second housing. When the electrical connector and the mating connector are mated, the conductive terminal is in contact with the mating conductive terminal.

With the rapid development of industries such as electric vehicles, a technical challenge faced by those of ordinary skill in the art is how to efficiently transfer power from a charging port to a battery pack. Due to issues such as cumulative tolerances, in the related art, it is difficult to dock with the electrical connector and the mating connector when mating, resulting in inconvenient operation.

In the related art, the conductive terminal of the electrical connector often requires the removal of a protective cover and the use of an external tool to achieve alignment with the mating conductive terminal. This engagement process is cumbersome. Besides, the removal of the protective cover exposes conductive components, creating a risk of electric shock.

Additionally, the sealing design of the electrical connector and mating connector in the related art leaves room for improvement.

### SUMMARY

The present disclosure adopts the following technical solution: a mating connector, including: a housing including a main body portion and an installation portion, the installation portion including a protrusion; a mating terminal at least partially disposed in the main body portion, the mating terminal including a mating portion extending in a direction, the direction being perpendicular to another direction; a locking device slidably installed on the main body portion along the another direction, the locking device including a slider having an elastic arm, the elastic arm locking with the protrusion along the another direction; and a rotating cover installed on the main body portion, the rotating cover driving the mating terminal to move along the direction; wherein the rotating cover defines a slot, and the slider is provided with a tab mating with the slot.

### BRIEF DESCRIPTION OF DRAWINGS

FIG. 1 is a perspective view of a connector assembly in a mated state in accordance with a first embodiment of the present disclosure;

FIG. 2 is another perspective view of FIG. 1 from another angle;

FIG. 3 is an exploded perspective view of FIG. 1, showing an electrical connector and a mating connector separated from each other;

FIG. 4 is another exploded perspective view of FIG. 3 from another angle;

FIG. 5 is a partially exploded perspective view of the electrical connector in FIG. 4;

FIG. 6 is another partially exploded perspective view of FIG. 5 from another angle;

FIG. 7 is an exploded perspective view of an end cover, a first sealing ring, a first cable, a first terminal mounting block, a second cable, and a second terminal mounting block in FIG. 6;

FIG. 8 is another exploded perspective view of FIG. 7 from another angle;

FIG. 9 is an exploded perspective view of the first terminal mounting block and the second terminal mounting block in FIG. 7;

FIG. 10 is another exploded perspective view of FIG. 9 from another angle;

FIG. 11 is a cross-sectional view taken along line D-D of FIG. 3;

FIG. 12 is a partially exploded view of FIG. 11, showing a second sealing ring and a retaining cover separated;

FIG. 13 is a cross-sectional view taken along line E-E of FIG. 3;

FIG. 14 is a partially exploded view of FIG. 13, showing the second sealing ring and the retaining cover separated;

FIG. 15 is a perspective view of a connector assembly in a mated state in accordance with a second embodiment of the present disclosure;

FIG. 16 is a perspective view of an end cover, a first sealing ring, a first cable, a first terminal mounting block, a second cable, a second terminal mounting block, a first retaining sleeve and a second retaining sleeve which are assembled together in FIG. 15;

FIG. 17 is a partially exploded perspective view of FIG. 16, showing the first retaining sleeve and the second retaining sleeve separated;

FIG. 18 is a further exploded perspective view of FIG. 17;

FIG. 19 is another exploded perspective view of FIG. 18 from another angle;

FIG. 20 is a cross-sectional view taken along line H-H of FIG. 15;

FIG. 21 is an enlarged partial view of frame part J in FIG. 20;

FIG. 22 is a cross-sectional view taken along line I-I of FIG. 15;

FIG. 23 is an enlarged partial view of frame part K in FIG. 22;

FIG. 24 is another perspective view of the mating connector in FIG. 2 from another angle, showing a first rotating cover and a second rotating cover not yet fully rotated;

FIG. 25 is a perspective view of FIG. 24 in another state, showing the first rotating cover and second rotating cover fully rotated;

FIG. 26 is a partially exploded perspective view of the mating connector in FIG. 2, showing a locking device and an installation assembly separated;

FIG. 27 is another partially exploded perspective view of FIG. 26 from another angle;

FIG. 28 is a partially exploded perspective view of the mating connector in FIG. 25, showing the locking device separated;

FIG. 29 is an exploded perspective view of the locking device in FIG. 26;

FIG. 30 is another exploded perspective view of FIG. 29 from another angle;

FIG. 31 is a partially exploded perspective view of the mating connector in FIG. 2, showing the installation assembly separated;

FIG. 32 is a left view of the installation assembly in FIG. 31;

FIG. 33 is a perspective view of the installation assembly in FIG. 30 in an initial state;

FIG. 34 is a partially exploded perspective view of FIG. 33, showing a pin separated;

FIG. 35 is a left view of FIG. 34;

FIG. 36 is a cross-sectional view taken along line M-M of FIG. 33;

FIG. 37 is a cross-sectional view taken along line L-L of FIG. 32;

FIG. 38 is a further exploded perspective view of FIG. 34;

FIG. 39 is another exploded perspective view of FIG. 38 from another angle;

FIG. 40 is a partially exploded perspective view of FIG. 25 with the locking device and the installation assembly removed;

FIG. 41 is another partially exploded perspective view of FIG. 40 from another angle;

FIG. 42 is a further partially exploded perspective view of FIG. 40;

FIG. 43 is another partially exploded perspective view of FIG. 42 from another angle;

FIG. 44 is an exploded perspective view of a first conductive terminal module, a portion of a first terminal module, a second conductive terminal module and a portion of a second terminal module in FIG. 42;

FIG. 45 is another exploded perspective view of FIG. 44 from another angle;

FIG. 46 is a partially exploded perspective view of FIG. 25 with the locking device and the installation assembly removed, showing a third mating sealing ring, a fourth mating sealing ring and the second rotating cover separated;

FIG. 47 is another partially exploded perspective view of FIG. 46 from another angle;

FIG. 48 is a further partially exploded perspective view of FIG. 46, showing the second retaining sleeve separated;

FIG. 49 is a cross-sectional view taken along line F-F of FIG. 3;

FIG. 50 is an enlarged partial view of frame part N in FIG. 49;

FIG. 51 is a cross-sectional view of FIG. 50 in accordance with another embodiment of the present disclosure;

FIG. 52 is a cross-sectional view of FIG. 50 in another state, showing the first rotating cover not fully rotated;

FIG. 53 is a cross-sectional view taken along line G-G of FIG. 3;

FIG. 54 is an enlarged partial view of frame part O in FIG. 53;

FIG. 55 is a cross-sectional view of FIG. 54 in accordance with another embodiment of the present disclosure;

FIG. 56 is a cross-sectional view of FIG. 54 in another state, showing the second rotating cover not fully rotated;

FIG. 57 is a top view of FIG. 2, showing the locking device in an unlocked position;

FIG. 58 is a top view of FIG. 57 in another state, showing the locking device in a locked position;

FIG. 59 is a cross-sectional view taken along line P-P of FIG. 57;

FIG. 60 is a cross-sectional view taken along line Q-Q of FIG. 58;

FIG. 61 is an enlarged partial view of frame part R in FIG. 60;

FIG. 62 is a cross-sectional view taken along line B-B of FIG. 1, showing the electrical connector and the mating connector separated; and

FIG. 63 is a cross-sectional view taken along line C-C of FIG. 1.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

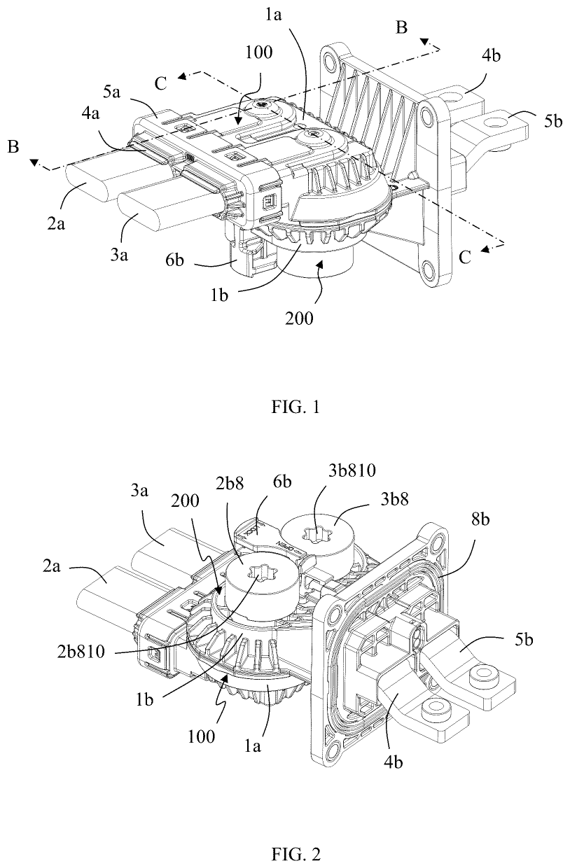

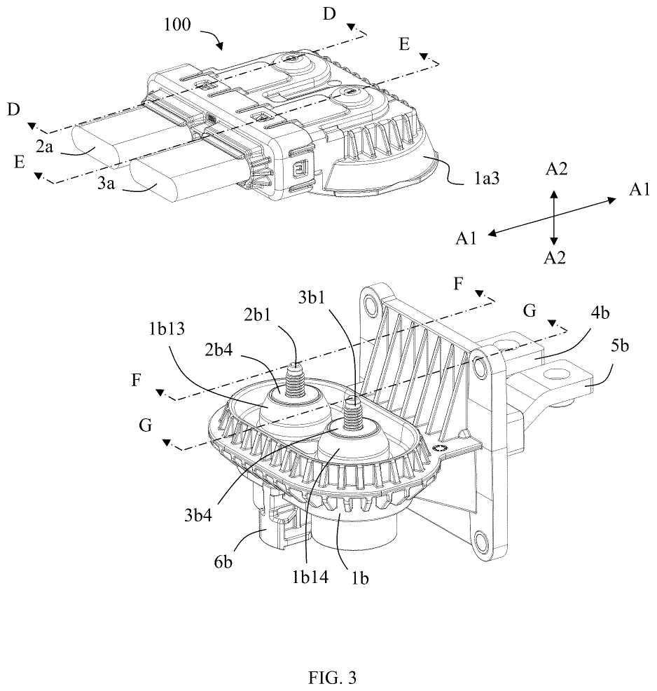

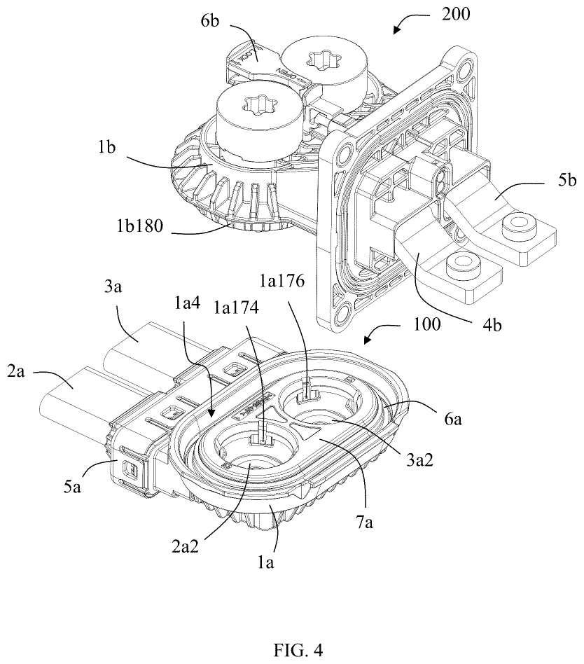

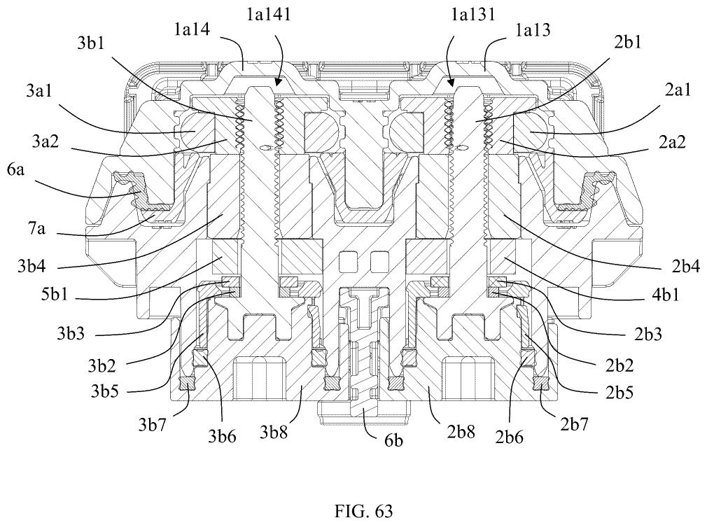

Referring to FIG. 1 to FIG. 63, the present disclosure discloses a connector assembly, including an electrical connector 100 and a mating connector 200 for mating with the electrical connector 100. In one embodiment of the present disclosure, the connector assembly is used in new energy vehicles to transfer power from a charging station to a battery pack. In the illustrated embodiment of the present disclosure, the electrical connector 100 is a plug cable-end connector, which is used to connect to a power source; and the mating connector 200 is a receptacle board-end connector, which is used to electrically connect to the battery pack.

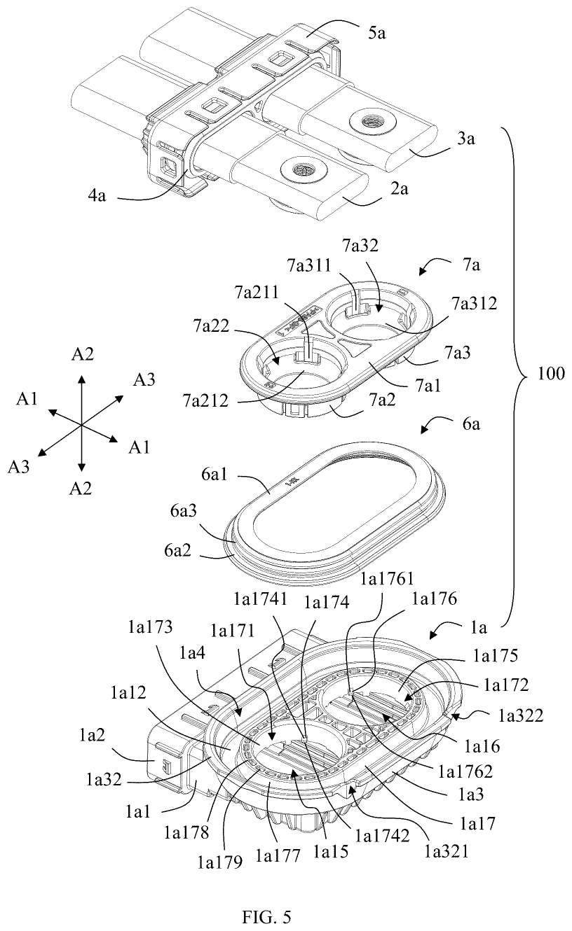

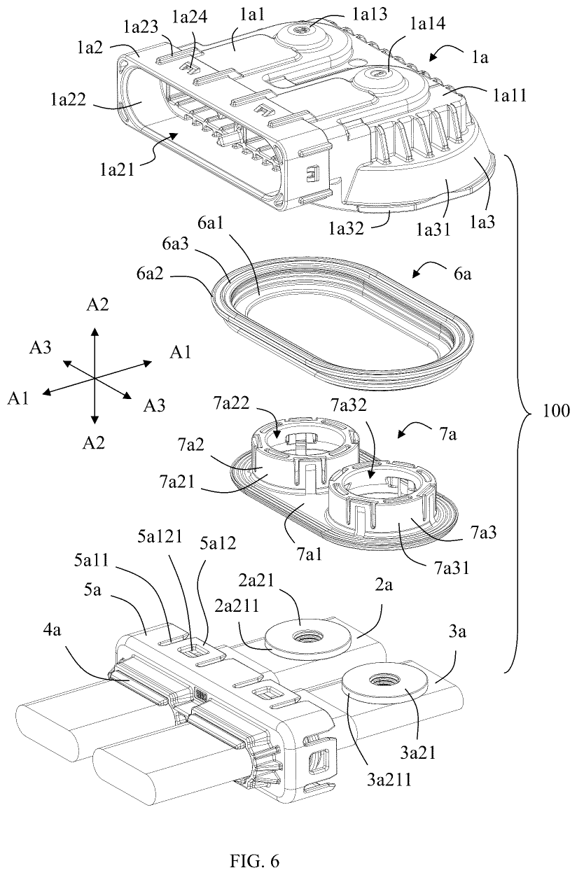

Referring to FIG. 5 and FIG. 6, in the illustrated embodiment of the present disclosure, the electrical connector 100 includes a first housing 1a, a first cable assembly 2a at least partially disposed in the first housing 1a, a second cable assembly 3a at least partially disposed in the first housing 1a, a first sealing ring 4a mating with the first cable assembly 2a and the second cable assembly 3a, an end cover 5a secured to the first housing 1a, a second sealing ring 6a installed in the first housing 1a, and a retaining cover 7a secured to the first housing 1a.

In one embodiment of the present disclosure, the first housing 1a is made of insulating material, and includes a first main body portion 1a1, a first installation portion 1a2 integrally extending from the first main body portion 1a1 along a first direction A1-A1 (for example, a front-rear direction), and a first shielding portion 1a3 integrally extending from the first main body portion 1a1 along a second direction A2-A2 (for example, a top-bottom direction). The first direction A1-A1 and the second direction A2-A2 are perpendicular to each other. The first shielding portion 1a3 protrudes downwardly beyond the first main body portion 1a1 and the first installation portion 1a2 along the second direction A2-A2.

The first main body portion 1a1 includes a first outer wall portion 1a11, a first inner wall portion 1a12, a first raised portion 1a13 protruding upwardly beyond the first outer wall portion 1a11 along the second direction A2-A2, a second raised portion 1a14 protruding upwardly beyond the first outer wall portion 1a11 along the second direction A2-A2, a first terminal receiving slot 1a15 located between the first outer wall portion 1a11 and the first inner wall portion 1a12, a second terminal receiving slot 1a16 located between the first outer wall portion 1a11 and the first inner wall portion 1a12, and a first protrusion portion 1a17 protruding downwardly beyond the first inner wall portion 1a12 along the second direction A2-A2.

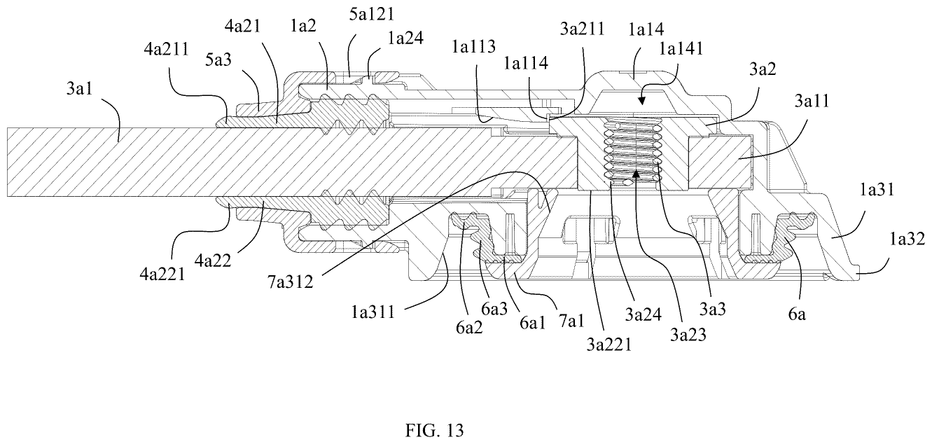

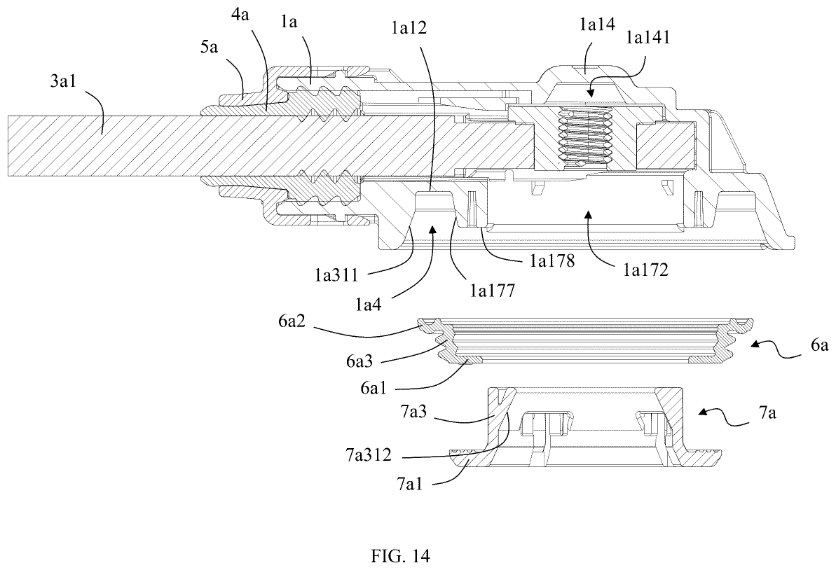

The first raised portion 1a13 and the second raised portion 1a14 are spaced apart with each other along a third direction A3-A3 (for example, a left-right direction). An inner side of the first raised portion 1a13 is provided with a first recessed space 1a131 (as shown in FIG. 11), and the first recessed space 1a131 is in communication with the first terminal receiving slot 1a15 along the second direction A2-A2. Similarly, an inner side of the second raised portion 1a14 is provided with a second recessed space 1a141 (as shown in FIG. 13), and the second recessed space 1a141 is in communication with the second terminal receiving slot 1a16 along the second direction A2-A2. The third direction A3-A3 is perpendicular to the first direction A1-A1 and the second direction A2-A2.

Referring to FIG. 11, in the illustrated embodiment of the present disclosure, an inner side of the first outer wall portion 1a11 is provided with a first guiding inclined surface 1a111 inclined along the first direction A1-A1 and a first locking surface 1a112 extending along the second direction A2-A2. The first guiding inclined surface 1a111 is configured to guide insertion of the first cable assembly 2a into the first terminal receiving slot 1a15. The first locking surface 1a112 is configured to lock with the first cable assembly 2a when the first cable assembly 2a is inserted in place, in order to prevent the first cable assembly 2a from falling out of the first terminal receiving slot 1a15.

Similarly, referring to FIG. 13, in the illustrated embodiment of the present disclosure, the inner side of the first outer wall portion 1a11 is further provided with a second guiding inclined surface 1a113 inclined along the first direction A1-A1, and a second locking surface 1a114 extending along the second direction A2-A2. The second guiding inclined surface 1a113 is configured to guide insertion of the second cable assembly 3a into the second terminal receiving slot 1a16. The second locking surface 1a114 is configured to lock with the second cable assembly 3a when the second cable assembly 3a is inserted in place, in order to prevent the second cable assembly 3a from falling out of the second terminal receiving slot 1a16.

Referring to FIG. 5, the first protrusion portion 1a17 includes a first mounting hole 1a171 communicating with the first terminal receiving slot 1a15, and a second mounting hole 1a172 communicating with the second terminal receiving slot 1a16. In the illustrated embodiment of the present disclosure, the first mounting hole 1a171 and the second mounting hole 1a172 are spaced apart along the third direction A3-A3. The first mounting hole 1a171 and the second mounting hole 1a172 are both cylindrical holes. The first main body portion 1a1 includes a first inner surface 1a173 exposed in the first mounting hole 1a171, and at least one first retaining protrusion 1a174 protruding from the first inner surface 1a173. In the illustrated embodiment of the present disclosure, the first inner surface 1a173 is cylindrical, and a plurality of first retaining protrusion 1a174 are provided and spaced apart along a circumference of the first inner surface 1a173. In the illustrated embodiment of the present disclosure, the first retaining protrusion 1a174 is integrally formed with the first main body portion 1a1 so as to improve structural strength. Each first retaining protrusion 1a174 includes a first inclined surface 1a1741 and a first abutting surface 1a1742.

Similarly, the second main body portion 1a1 includes a second inner surface 1a175 exposed in the second mounting hole 1a172, and at least one second retaining protrusion 1a176 protruding from the second inner surface 1a175. In the illustrated embodiment of the present disclosure, the second inner surface 1a175 is cylindrical, and a plurality of second retaining protrusions 1a176 are provided and spaced apart along a circumference of the second inner surface 1a175. In the illustrated embodiment of the present disclosure, the second retaining protrusion 1a176 is integrally formed with the first main body portion 1a1 so as to improve structural strength. Each second retaining protrusion 1a176 includes a second inclined surface 1a1761 and a second abutting surface 1a1762.

In the illustrated embodiment of the present disclosure, the first shielding portion 1a3 is disposed around a periphery of the first protrusion portion 1a17. The first housing 1a includes a first annular groove 1a4 located between the first shielding portion 1a3 and the first protrusion portion 1a17. The first inner wall portion 1a12 is exposed downwardly in the first annular groove 1a4. The first protrusion portion 1a17 is provided with a first conical surface 1a177 exposed outward in the first annular groove 1a4, and a first bottom surface 1a178 located at a bottom of the first protrusion portion 1a17. In the illustrated embodiment of the present disclosure, the first protrusion portion 1a17 defines a plurality of first escape holes 1a179 extending through the first bottom surface 1a178 along the second direction A2-A2.

Referring to FIG. 6, the first installation portion 1a2 is provided with a installation channel 1a21 which communicates with the first terminal receiving slot 1a15 and the second terminal receiving slot 1a16, and a first inner side surface 1a22 which is exposed in the installation channel 1a21. The first inner side surface 1a22 is generally elliptical. The first installation portion 1a2 is further provided with a plurality of positioning ribs 1a23 and a plurality of locking blocks 1a24 on an outer side surface thereof.

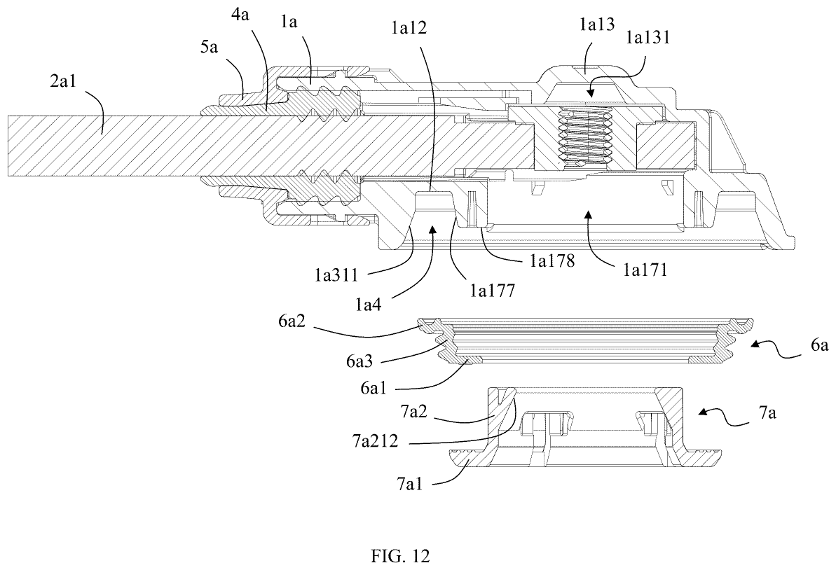

The first shielding portion 1a3 includes a first conical portion 1a31 and a first flange portion 1a32 extending outward from a bottom of the first conical portion 1a31. The first conical portion 1a31 includes a second conical surface 1a311 on an inner side thereof. Referring to FIG. 12, in the illustrated embodiment of the present disclosure, the first conical surface 1a177 and the second conical surface 1a311 are inclined in opposite directions to form a flap opening, which facilitates the insertion of guiding components. Referring to FIG. 5, in the illustrated embodiment of the present disclosure, the first flange portion 1a32 is provided with a first relief groove 1a321 and a second relief groove 1a322 which extend through the first flange portion 1a32 along the second direction A2-A2. The first relief groove 1a321 and the second relief groove 1a322 are spaced apart, and both located on a side opposite to the first installation portion 1a2.

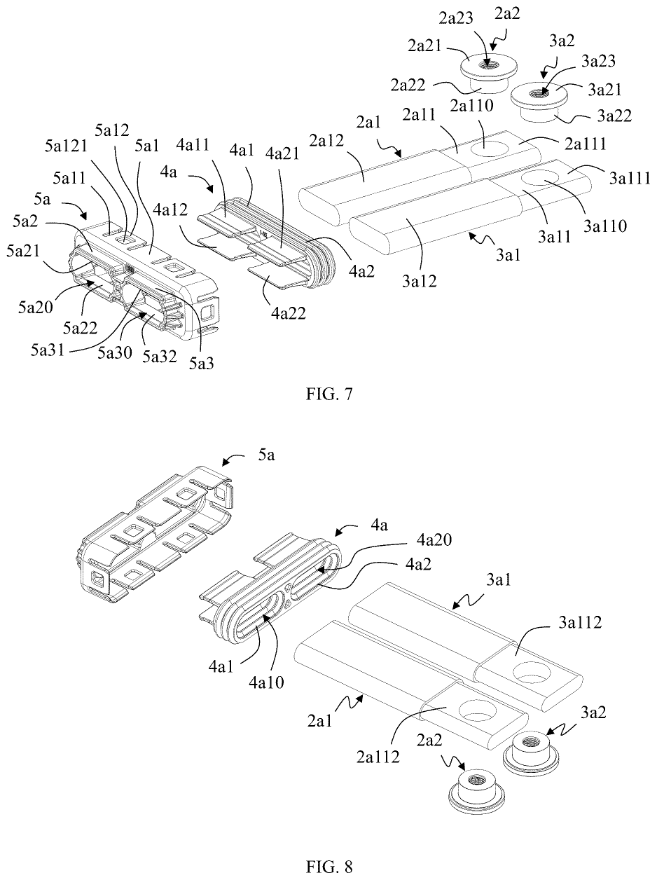

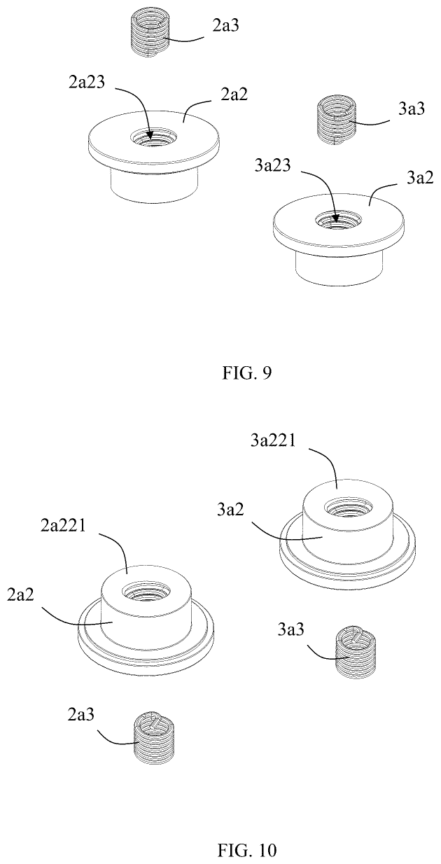

Referring to FIG. 7 and FIG. 8, in the first embodiment of the present disclosure, the first cable assembly 2a includes a first cable 2a1 and a first terminal mounting block 2a2 fixed to the first cable 2a1. In one embodiment of the present disclosure, the first cable 2a1 is flat, and includes a first core 2a11 and a first insulating layer 2a12 wrapped around the first core 2a11. In one embodiment of the present disclosure, the first core 2a11 is made of aluminum to reduce weight. The first core 2a11 is provided with a first surface 2a111 (for example, an upper surface), a second surface 2a112 (for example, a lower surface) disposed opposite to the first surface 2a111, and a first mounting hole 2a110 extending through the first surface 2a111 and the second surface 2a112 along the second direction A2-A2.

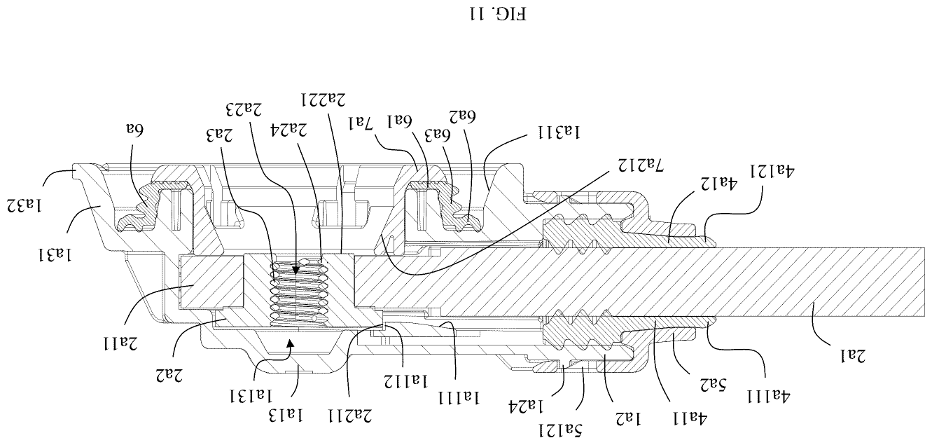

The first terminal mounting block 2a2 is at least partially fixed in the first mounting hole 2a110. In one embodiment of the present disclosure, the first terminal mounting block 2a2 is soldered or welded to the first core 2a11. In one embodiment of the present disclosure, the first terminal mounting block 2a2 is made of copper to improve soldering or welding quality. Of course, it is understandable to those skilled in the art that in other embodiments of the present disclosure, the first terminal mounting block 2a2 can also be fixed to the first core 2a11 by other fixing methods, such as riveting. In some embodiments of the present disclosure, the first cable assembly 2a may not even include the first terminal mounting block 2a2. In this case, the first mounting hole 2a110 serves as a first terminal mating hole 2a23 to mate with a mating terminal. The first terminal mounting block 2a2 includes a first base 2a21 and a first extension portion 2a22 integrally extending from the first base 2a21 along the second direction A2-A2. In the illustrated embodiment of the present disclosure, both the first base 2a21 and the first extension portion 2a22 are cylindrical. A diameter of the first base 2a21 is greater than a diameter of the first extension portion 2a22. The first terminal mounting block 2a2 further defines a first terminal mating hole 2a23. In the illustrated embodiment of the present disclosure, the first terminal mating hole 2a23 extends through the first base 2a21 and the first extension portion 2a22 along the second direction A2-A2. The first terminal mating hole 2a23 is a first threaded hole to improve mating reliability. The first extension portion 2a22 is provided with a first exposed surface 2a221 exposed downwardly in the first receiving cavity 7a22 along the second direction A2-A2 (as shown in FIG. 10).

Preferably, to further improve mating reliability, in one embodiment of the present disclosure, the first cable assembly 2a includes a first thread sleeve 2a3 installed in the first terminal mating hole 2a23. In the illustrated embodiment of the present disclosure, the first terminal mating hole 2a23 is a first threaded hole; the first thread sleeve 2a3 is in a form of a coiled spring, and secured in the first threaded hole. Referring to FIG. 11, in one embodiment of the present disclosure, an inner wall of the first extension portion 2a22 is provided with a first blocking protrusion 2a24 protruding into the first terminal mating hole 2a23. The first blocking protrusion 2a24 is integrally formed with the first extension portion 2a22. The first blocking protrusion 2a24 is configured to prevent the first thread sleeve 2a3 from falling out of the first terminal mating hole 2a23 along the second direction A2-A2. In one embodiment of the present disclosure, the first thread sleeve 2a3 is made of stainless steel. Of course, it is understandable to those skilled in the art that in other embodiments of the present disclosure, the first thread sleeve 2a3 can also be made of other metal materials.

Referring to FIG. 7 and FIG. 8, in the first embodiment of the present disclosure, the second cable assembly 3a includes a second cable 3a1 and a second terminal mounting block 3a2 fixed to the second cable 3a1. In one embodiment of the present disclosure, the second cable 3a1 is flat, and includes a second core 3a11 and a second insulating layer 3a12 wrapping around the second core 3a11. In one embodiment of the present disclosure, the second core 3a11 is made of aluminum to reduce weight. The second core 3a11 is provided with a third surface 3a111 (for example, an upper surface), a fourth surface (for example, a lower surface) 3a112 disposed opposite to the third surface 3a111, and a second mounting hole 3a110 extending through the third surface 3a111 and the fourth surface 3a112 along the second direction A2-A2.

The second terminal mounting block 3a2 is at least partially secured in the second mounting hole 3a110. In one embodiment of the present disclosure, the second terminal mounting block 3a2 is soldered or welded to the second core 3a11. In one embodiment of the present disclosure, the second terminal mounting block 3a2 is made of copper to improve soldering or welding quality. Of course, it is understandable to those skilled in the art that in other embodiments of the present disclosure, the second terminal mounting block 3a2 can also be fixed to the second core 3a11 by other fixing methods, such as riveting. In some embodiments of the present disclosure, the second cable assembly 3a may not even include the second terminal mounting block 3a2. In this case, the second mounting hole 3a110 serves as a second terminal mating hole 3a23 to mate with a mating terminal. The second terminal mounting block 3a2 includes a second base 3a21 and a second extension portion 3a22 integrally extending from the second base 3a21 along the second direction A2-A2. In the illustrated embodiment of the present disclosure, both the second base 3a21 and the second extension portion 3a22 are cylindrical. A diameter of the second base 3a21 is greater than a diameter of the second extension portion 3a22. The second terminal mounting block 3a2 further defines a second terminal mating hole 3a23. In the illustrated embodiment of the present disclosure, the second terminal mating hole 3a23 extends through the second base 3a21 and the second extension portion 3a22 along the second direction A2-A2. The second terminal mating hole 3a23 is a second threaded hole to improve mating reliability. The second extension portion 3a22 is provided with a second exposed surface 3a221 exposed downwardly in the second receiving cavity 7a32 along the second direction A2-A2.

Preferably, to further improve mating reliability, in one embodiment of the present disclosure, the second cable assembly 3a includes a second thread sleeve 3a3 installed in the second terminal mating hole 3a23. In the illustrated embodiment of the present disclosure, the second terminal mating hole 3a23 is a second threaded hole; the second thread sleeve 3a3 is in a form of a coiled spring, and fixed in the second threaded hole. In one embodiment of the present disclosure, an inner wall of the second extension portion 3a22 is provided with a second blocking protrusion 3a24 protruding into the second terminal mating hole 3a23. The second blocking protrusion 3a24 is integrally formed with the second extension portion 3a22. The second blocking protrusion 3a24 is configured to prevent the second thread sleeve 3a3 from falling out of the second terminal mating hole 3a23 along the second direction A2-A2. In one embodiment of the present disclosure, the second thread sleeve 3a3 is made of stainless steel. Of course, it is understandable to those skilled in the art that in other embodiments of the present disclosure, the second thread sleeve 3a3 can also be made of other metal materials.

During assembly, the first extension portion 2a22 is inserted into the first mounting hole 2a110 and exposed on the second surface 2a112 of the first core 2a11. The first base 2a21 is located on a top of the first core 2a11 and abuts against the first surface 2a111. In the illustrated embodiment of the present disclosure, the first base 2a21 protrudes upwardly beyond the first surface 2a111 along the second direction A2-A2. The first base 2a21 is provided with a first engagement surface 2a211 protruding upwardly beyond the first surface 2a111. The first engagement surface 2a211 locks with the first locking surface 1a112 to secure the first cable assembly 2a in the first terminal receiving slot 1a15.

The second extension portion 3a22 is inserted into the second mounting hole 3a110 and exposed on the fourth surface 3a112 of the second core 3a11. The second base 3a21 is located on a top of the second core 3a11 and abuts against the third surface 3a111. In the illustrated embodiment of the present disclosure, the second base 3a21 protrudes upwardly beyond the third surface 3a111 along the second direction A2-A2. The second base 3a21 is provided with a second mating surface 3a211 protruding upwardly beyond the third surface 3a111. The second mating surface 3a211 locks with the second locking surface 1a114 to secure the second cable assembly 3a in the second terminal receiving slot 1a16.

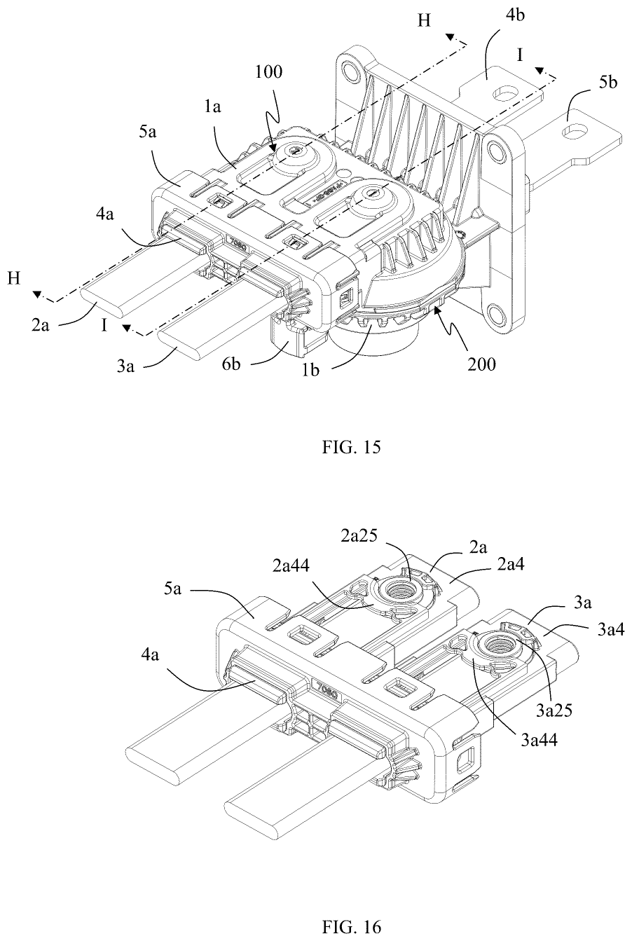

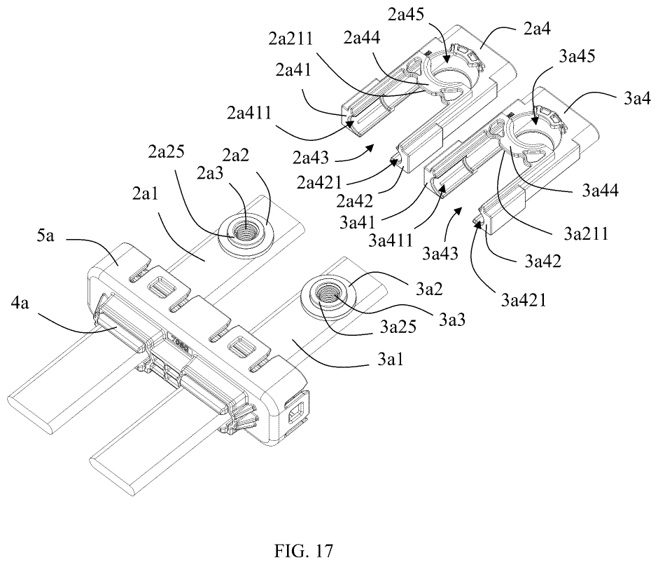

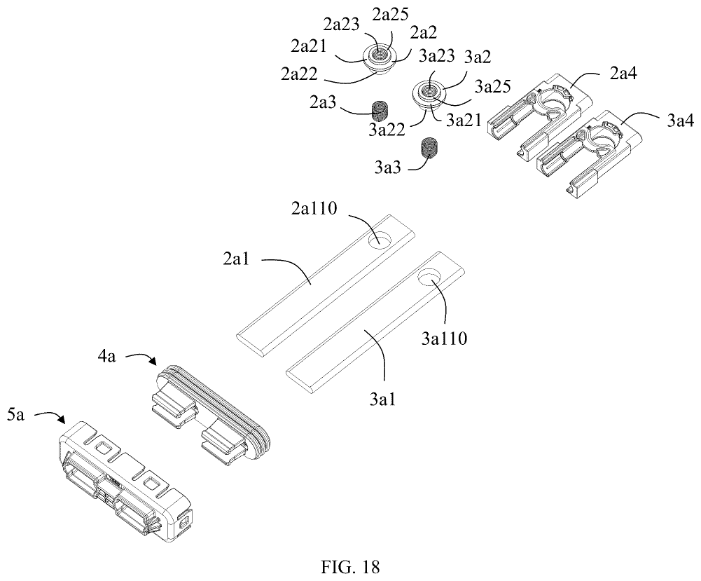

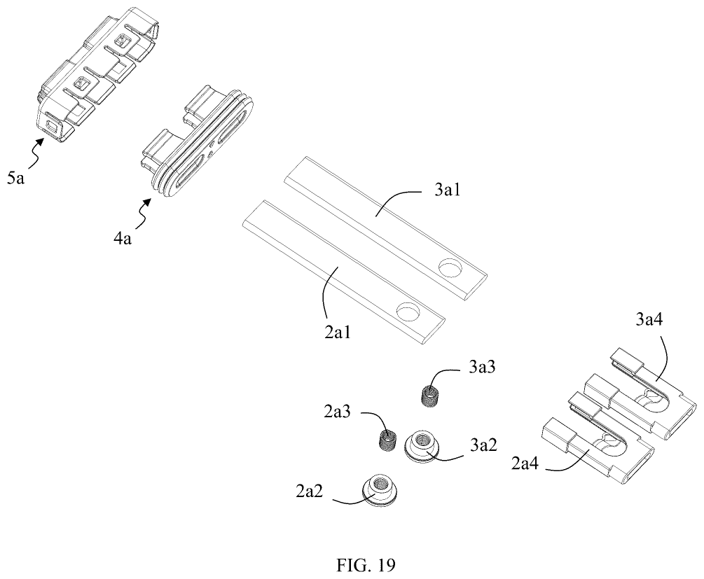

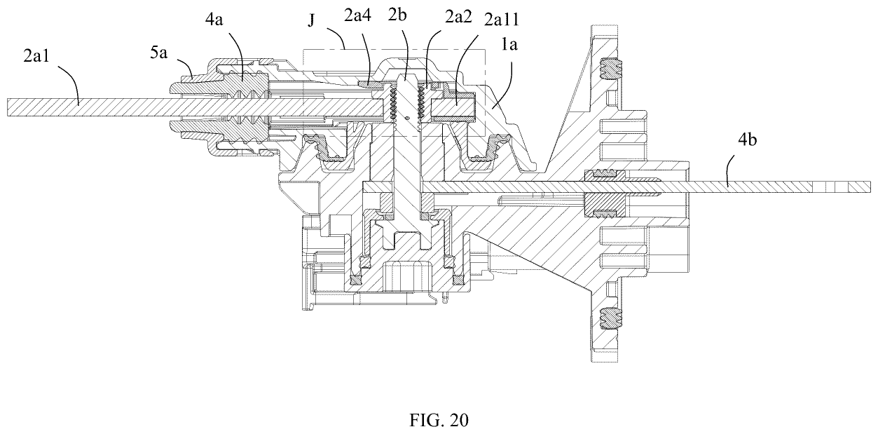

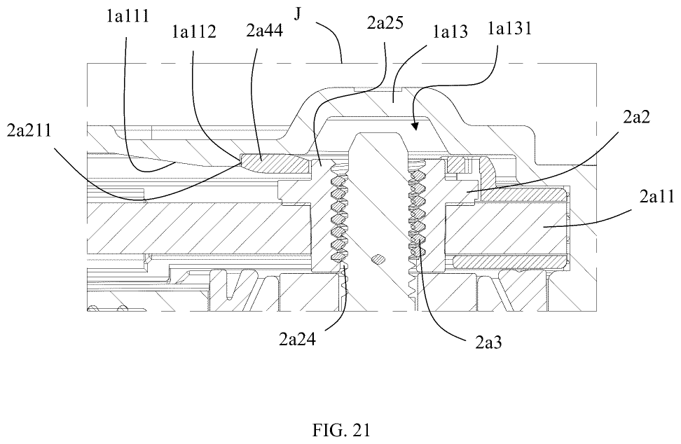

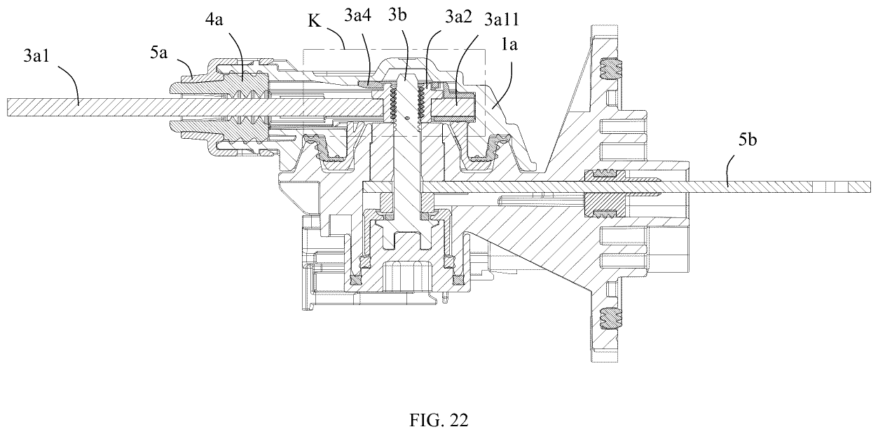

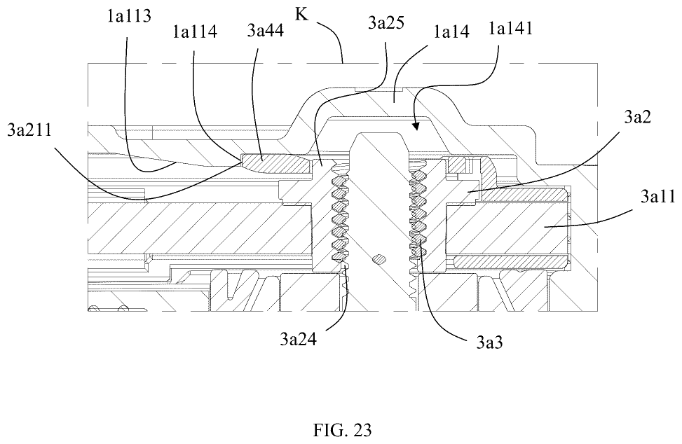

Referring to FIG. 15 to FIG. 23, in a second embodiment of the present disclosure, the first cable assembly 2a includes a first cable 2a1, a first terminal mounting block 2a2 secured to the first cable 2a1, a first thread sleeve 2a3 installed on the first terminal mounting block 2a2, and a first retaining sleeve 2a4 engaging with the first cable 2a1.

The first cable 2a1 in the second embodiment of the present disclosure is the same as the first cable 2a1 in the first embodiment of the present disclosure. The first thread sleeve 2a3 in the second embodiment of the present disclosure is the same as the first thread sleeve 2a3 in the first embodiment of the present disclosure. The first terminal mounting block 2a2 in the second embodiment of the present disclosure is similar to the first terminal mounting block 2a2 in the first embodiment of the present disclosure, except that the first terminal mounting block 2a2 in the second embodiment of the present disclosure is further provided with a first holding portion 2a25 protruding beyond the first base 2a21. The first holding portion 2a25 is generally cylindrical. The first holding portion 2a25 and the first extension portion 2a22 are located on opposite sides of the first base 2a21, respectively. The first terminal mating hole 2a23 further extends through the first holding portion 2a25.

Referring to FIG. 16 to FIG. 19, in the illustrated embodiment of the present disclosure, the first retaining sleeve 2a4 is made of insulating material (for example, nylon), and is generally U-shaped. The first retaining sleeve 2a4 includes a first side wall portion 2a41, a second side wall portion 2a42, a first accommodating space 2a43 located between the first side wall portion 2a41 and the second side wall portion 2a42, and a first connecting wall 2a44 connecting the first side wall portion 2a41 and the second side wall portion 2a42. The first connecting wall 2a44 spans over the first accommodating space 2a43. The first side wall portion 2a41 defines a first groove 2a411, and the second side wall portion 2a42 defines a second groove 2a421. The first groove 2a411, the second groove 2a421 and the first accommodating space 2a43 together form a first insertion slot for accommodating the first cable 2a1. The first connecting wall 2a44 has a certain degree of elastic deformation capability. The first retaining sleeve 2a4 includes a first retaining groove 2a45 located at one end of the first connecting wall 2a44.

Similarly, referring to FIG. 15 to FIG. 23, in the second embodiment of the present disclosure, the second cable assembly 3a includes a second cable 3a1, a second terminal mounting block 3a2 secured to the second cable 3a1, a second thread sleeve 3a3 installed on the second terminal mounting block 3a2, and a second retaining sleeve 3a4 engaging with the second cable 3a1.

The second cable 3a1 in the second embodiment of the present disclosure is the same as the second cable 3a1 in the first embodiment of the present disclosure. The second thread sleeve 3a3 in the second embodiment of the present disclosure is the same as the second thread sleeve 3a3 in the first embodiment of the present disclosure. The second terminal mounting block 3a2 in the second embodiment of the present disclosure is similar to the second terminal mounting block 3a2 in the first embodiment of the present disclosure, except that the second terminal mounting block 3a2 in the second embodiment of the present disclosure is further provided with a second holding portion 3a25 protruding beyond the second base 3a21. The second holding portion 3a25 is generally cylindrical. The second holding portion 3a25 and the second extension portion 3a22 are located on opposite sides of the second base 3a21, respectively. The second terminal mating hole 3a23 further extends through the second holding portion 3a25.

Referring to FIG. 16 to FIG. 19, in the illustrated embodiment of the present disclosure, the second retaining sleeve 3a4 is made of insulating material (for example, nylon) and is generally U-shaped. The second retaining sleeve 3a4 includes a third side wall portion 3a41, a fourth side wall portion 3a42, a second accommodating space 3a43 located between the third side wall portion 3a41 and the fourth side wall portion 3a42, and a second connecting wall 3a44 connecting the third side wall portion 3a41 and the fourth side wall portion 3a42. The second connecting wall 3a44 spans over the second accommodating space 3a43. The third side wall portion 3a41 defines a third groove 3a411, and the fourth side wall portion 3a42 defines a fourth groove 3a421. The third groove 3a411, the fourth groove 3a421 and the second accommodating space 3a43 together form a second insertion slot for accommodating the second cable 3a1. The second connecting wall 3a44 has a certain degree of elastic deformation capability. The second retaining sleeve 3a4 defines a second retaining groove 3a45 located at one end of the second connecting wall 3a44.

During assembly, the first holding portion 2a25 deforms the first connecting wall 2a44 to pass through the first connecting wall 2a44 and be retained in the first retaining groove 2a45. At this time, the first connecting wall 2a44 returns to its pre-deformation state to abut against the first holding portion 2a25, thereby preventing the first holding portion 2a25 from disengaging from the first retaining sleeve 2a4. The first connecting wall 2a44 is provided with a first engagement surface 2a211 protruding upwardly beyond the first surface 2a111. The first engagement surface 2a211 locks with the first locking surface 1a112 to secure the first cable assembly 2a in the first terminal receiving slot 1a15.

Similarly, the second holding portion 3a25 deforms the second connecting wall 3a44 to pass through the second connecting wall 3a44 and be retained in the second retaining groove 3a45. At this time, the second connecting wall 3a44 returns to its pre-deformation state to abut against the second holding portion 3a25, thereby preventing the second holding portion 3a25 from disengaging from the second retaining sleeve 3a4. The second connecting wall 3a44 is provided with a second mating surface 3a211 protruding upwardly beyond the third surface 3a111. The second mating surface 3a211 locks with the second locking surface 1a114 to secure the second cable assembly 3a in the second terminal receiving slot 1a16.

It is understandable to those skilled in the art that when the width, thickness, and other dimensions of the first cable 2a1 and the second cable 3a1 themselves are small, the use of the first retaining sleeve 2a4 and the second retaining sleeve 3a4 is beneficial for assembly. In addition, by adjusting the first retaining sleeve 2a4 and the second retaining sleeve 3a4, the adaptability can be increased, reducing the impact of the first cable 2a1 and the second cable 3a1 themselves.

Referring to FIG. 7 and FIG. 8, the first sealing ring 4a includes a first sleeve portion 4a1, a second sleeve portion 4a2, a first extension tab 4a11 and a second extension tab 4a12 respectively extending from upper and lower edges of the first sleeve portion 4a1 along the first direction A1-A1, and a third extension tab 4a21 and a fourth extension tab 4a22 respectively extending from upper and lower edges of the second sleeve portion 4a2 along the first direction A1-A1.

In the illustrated embodiment of the present disclosure, the first sleeve portion 4a1 and the second sleeve portion 4a2 are disposed along the third direction A3-A3. The first sleeve portion 4a1 and the second sleeve portion 4a2 are integrally formed. The first sleeve portion 4a1 defines a first through hole 4a10, and the first extension tab 4a11 and the second extension tab 4a12 are located on upper and lower sides of the first through hole 4a10, respectively. Similarly, the second sleeve portion 4a2 defines a second through hole 4a20, and the third extension tab 4a21 and the fourth extension tab 4a22 are located on upper and lower sides of the second through hole 4a20, respectively.

Referring to FIG. 7, the end cover 5a includes a base portion 5a1, a first frame portion 5a2 integrally extending from the base portion 5a1 along the first direction A1-A1, and a second frame portion 5a3 integrally extending from the base portion 5a1 along the first direction A1-A1. The first frame portion 5a2 and the second frame portion 5a3 are spaced apart along the third direction A3-A3. In the illustrated embodiment of the present disclosure, the first extension tab 4a11 extends beyond the first frame portion 5a2 along the first direction A1-A1.

Specifically, Referring to FIG. 11 and FIG. 13, the first extension tab 4a11 includes a first stop portion 4a111 extending beyond the first frame portion 5a2 along the first direction A1-A1. The first stop portion 4a111 is located at a free end of the first extension tab 4a11 and is of a raised configuration. This arrangement is beneficial for improving the reliability of keeping the first extension tab 4a11 between the first frame portion 5a2 and the first cable 2a1, increasing damping, reducing the risk of loosening of the end cover 5a, and preventing relative wear between the housings during vibration. It is also beneficial for improving the sealing performance of the first extension tab 4a11. Similarly, the second extension tab 4a12 includes a second stop portion 4a121 extending beyond the first frame portion 5a2 along the first direction A1-A1. The second stop portion 4a121 is located at a free end of the second extension tab 4a12 and is of a raised configuration. This arrangement is beneficial for improving the reliability of keeping the second extension tab 4a12 between the first frame portion 5a2 and the first cable 2a1, increasing damping, reducing the risk of loosening of the end cover 5a, and preventing relative wear between the housings during vibration. It is also beneficial for improving the sealing performance of the second extension tab 4a12. The third extension tab 4a21 includes a third stop portion 4a211 extending beyond the second frame portion 5a3 along the first direction A1-A1. The third stop portion 4a211 is located at a free end of the third extension tab 4a21 and is of a raised configuration. This arrangement is beneficial for improving the reliability of keeping the third extension tab 4a21 between the second frame portion 5a3 and the second cable 3a1, increasing damping, reducing the risk of loosening of the end cover 5a, and preventing relative wear between the housings during vibration. It is also beneficial for improving the sealing performance of the third extension tab 4a21. Similarly, the fourth extension tab 4a22 includes a fourth stop portion 4a221 extending beyond the second frame portion 5a3 along the first direction A1-A1. The fourth stop portion 4a221 is located at a free end of the fourth extension tab 4a22 and is of a raised configuration. This arrangement is beneficial for improving the reliability of keeping the fourth extension tab 4a22 between the second frame portion 5a3 and the second cable 3a1, increasing damping, reducing the risk of loosening of the end cover 5a, and preventing relative wear between the housings during vibration. It is also beneficial for improving the sealing performance of the fourth extension tab 4a22.

The base portion 5a1 is provided with a plurality of positioning slots 5a11 and a plurality of locking tabs 5a12. The positioning slots 5a11 mate with the positioning ribs 1a23. Each locking tab 5a12 defines a locking hole 5a121 extending through the locking tab 5a12 along the second direction A2-A2. The locking hole 5a121 locks with the locking block 1a24. The first frame portion 5a2 is provided with a first installation slot 5a20, a first inner wall surface 5a21 exposed in the first installation slot 5a20, and a second inner wall surface 5a22 exposed in the first installation slot 5a20 and disposed opposite to the first inner wall surface 5a21. Similarly, the second frame portion 5a3 is provided with a second installation slot 5a30, a third inner wall surface 5a31 exposed in the second installation slot 5a30, and a fourth inner wall surface 5a32 exposed in the second installation slot 5a30 and disposed opposite to the third inner wall surface 5a31.

Referring to FIG. 5 and FIG. 6, the second sealing ring 6a includes a first sealing portion 6a1 located on an inner side, a second sealing portion 6a2 located on an outer side, and a third sealing portion 6a3 connecting the first sealing portion 6a1 and the second sealing portion 6a2. In the illustrated embodiment of the present disclosure, the first sealing portion 6a1, the second sealing portion 6a2 and the third sealing portion 6a3 are of a stepped configuration, with the first sealing portion 6a1 located below the second sealing portion 6a2. In other words, the second sealing ring 6a includes an axial sealing portion and a radial sealing portion to reduce the risk of sealing failure. In the illustrated embodiment of the present disclosure, the axial sealing portion includes the first sealing portion 6a1 and the second sealing portion 6a2, and the radial sealing portion includes the third sealing portion 6a3.

Referring to FIG. 5 and FIG. 6, the retaining cover 7a includes a pressing plate portion 7a1, a first sleeve portion 7a2 extending upwardly from the pressing plate portion 7a1 along the second direction A2-A2, and a second sleeve portion 7a3 extending upwardly from the pressing plate portion 7a1 along the second direction A2-A2. In the illustrated embodiment of the present disclosure, the pressing plate portion 7a1, the first sleeve portion 7a2 and the second sleeve portion 7a3 are integrally formed. The first sleeve portion 7a2 is generally cylindrical, and includes a first surrounding wall 7a21 and a first receiving cavity 7a22 surrounded by the first surrounding wall 7a21. The first surrounding wall 7a21 is received in the first mounting hole 1a171. The first surrounding wall 7a21 defines at least one first locking groove 7a211 extending through the first surrounding wall 7a21. The first surrounding wall 7a21 is provided with a first inclined surface 7a212 exposed in the first receiving cavity 7a22. The first inclined surface 7a212 and the second conical surface 1a311 are both configured to guide the insertion of the mating connector 200.

Similarly, the second sleeve portion 7a3 is generally cylindrical, and includes a second surrounding wall 7a31 and a second receiving cavity 7a32 surrounded by the second surrounding wall 7a31. The second surrounding wall 7a31 is received in the second mounting hole 1a172. The second surrounding wall 7a31 defines at least one second locking groove 7a311 extending through the second surrounding wall 7a31. The second surrounding wall 7a31 is provided with a second inclined surface 7a312 exposed in the second receiving cavity 7a32, and the second inclined surface 7a312 and the second conical surface 1a311 are both configured to guide the insertion of the mating connector 200. The first locking groove 7a211 locks with the first retaining protrusion 1a174, and the second locking groove 7a311 locks with the second retaining protrusion 1a176 to keep the retaining cover 7a in the first housing 1a. Alternatively, when the retaining cover 7a is locked in place, the first inclined surface 1a1741 of the first retaining protrusion 1a174 and the second inclined surface 1a1761 of the second retaining protrusion 1a176 protrude into the first mounting hole 1a171 and the second mounting hole 1a172, respectively. At this time, the first retaining protrusion 1a174 and the second retaining protrusion 1a176 can also serve to guide the insertion of the mating connector 200.

When assembling the electrical connector 100, the first cable assembly 2a and the second cable assembly 3a are assembly firstly. Then, the first core 2a11 and the second core 3a11 pass through the first installation slot 5a20 and the second installation slot 5a30 of the end cover 5a. Then, the first core 2a11 and the second core 3a11 pass through the first through hole 4a10 and the second through hole 4a20 of the first sealing ring 4a. Then, the first cable assembly 2a and the second cable assembly 3a are inserted into the first terminal receiving slot 1a15 and the second terminal receiving slot 1a16 through the installation channel 1a21. The first sleeve portion 4a1 and the second sleeve portion 4a2 of the first sealing ring 4a are respectively sealed and retained on the inner side of the base portion 5a1 to seal the first cable 2a1 and the second cable 3a1. The first extension tab 4a11 and the second extension tab 4a12 respectively fill the gap between the first frame portion 5a2 and the first cable 2a1. The third extension tab 4a21 and the fourth extension tab 4a22 respectively fill the gap between the second frame portion 5a3 and the second cable 3a1. As a result, the sealing effect is improved, and the risk of loosening of the end cover 5a is reduced. Then, the end cover 5a is locked and fixed to the first installation portion 1a2 of the first housing 1a. Specifically, the end cover 5a and the first installation portion 1a2 are provided with mutually lockable locking blocks 1a24 and locking holes 5a121. In the illustrated embodiment of the present disclosure, the locking blocks 1a24 are provided on the first installation portion 1a2, and the locking holes 5a121 are provided on the end cover 5a. Of course, it is understandable to those skilled in the art that the positions of the locking blocks 1a24 and the locking holes 5a121 can be interchanged, that is, the locking blocks 1a24 can be provided on the end cover 5a, and the locking holes 5a121 can be provided on the first installation portion 1a2.

Then, the second sealing ring 6a is installed on the first housing 1a, with the first sealing portion 6a1 abutting against the first bottom surface 1a178, the second sealing portion 6a2 received in the first annular groove 1a4 and abutting against the first inner wall portion 1a12, and the third sealing portion 6a3 abutting against the first conical surface 1a177.

Finally, the retaining cover 7a is installed and fix on the first housing 1a, with the pressing plate portion 7a1 abutting against the first sealing portion 6a1 to achieve axial sealing.

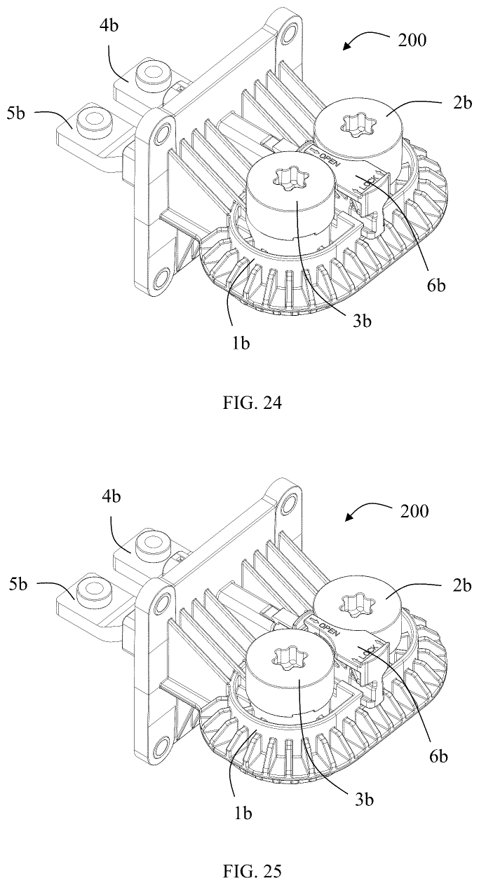

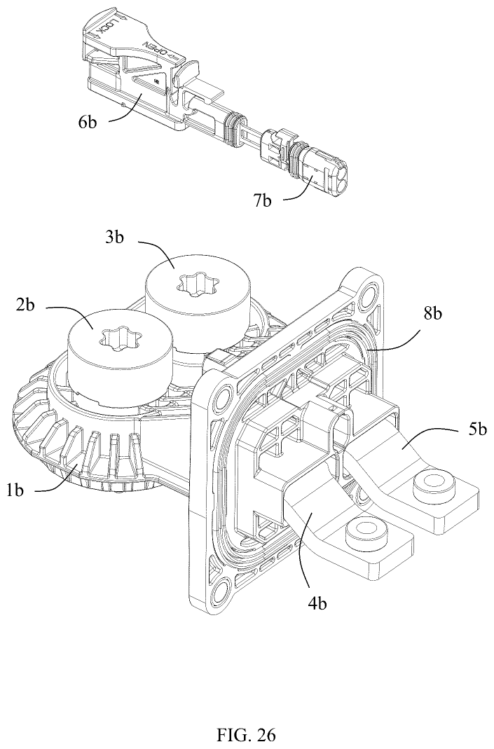

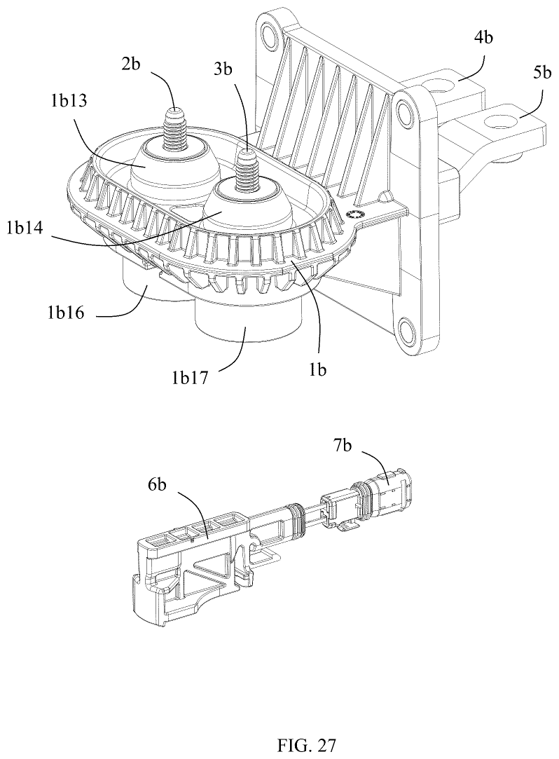

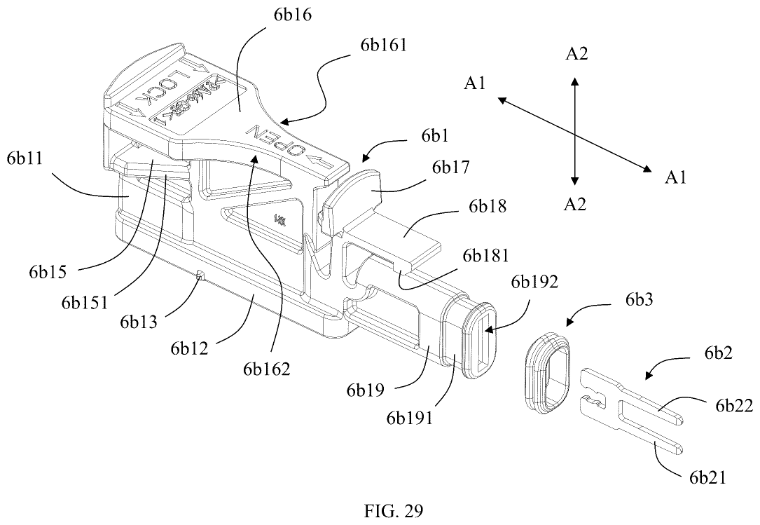

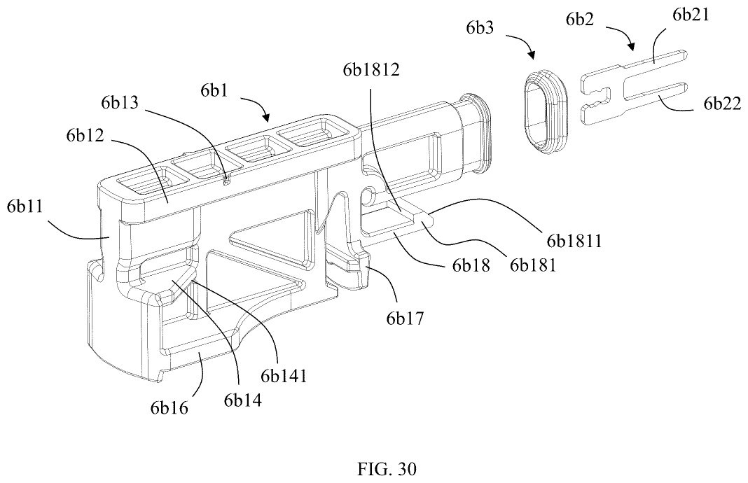

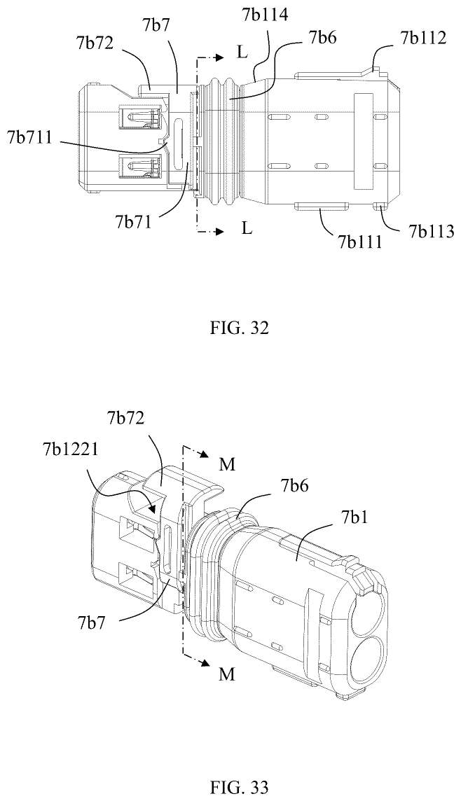

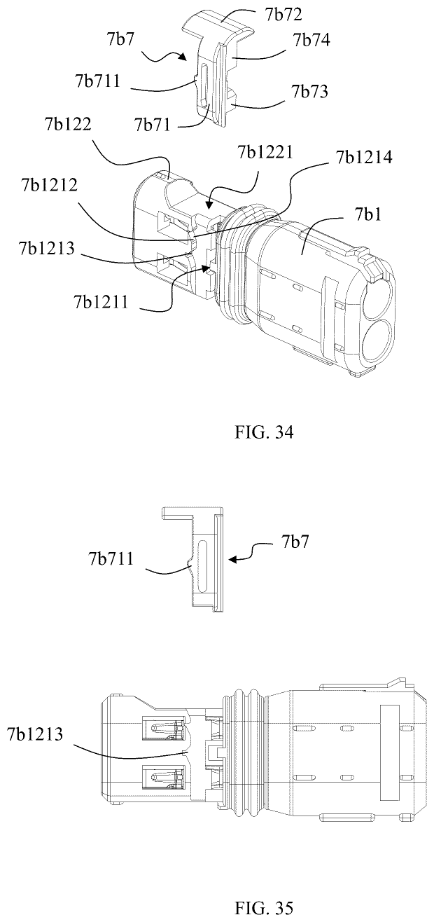

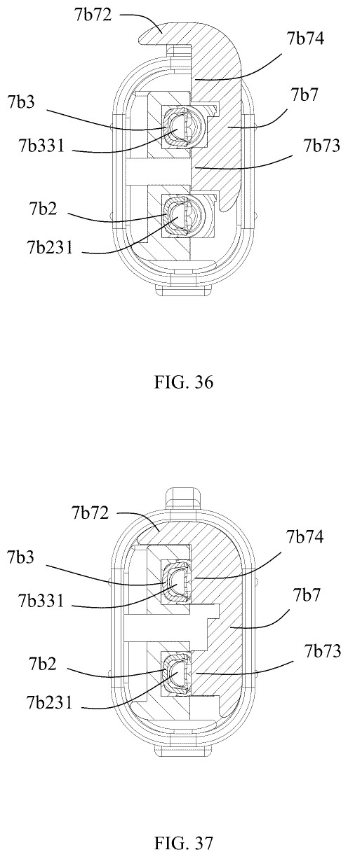

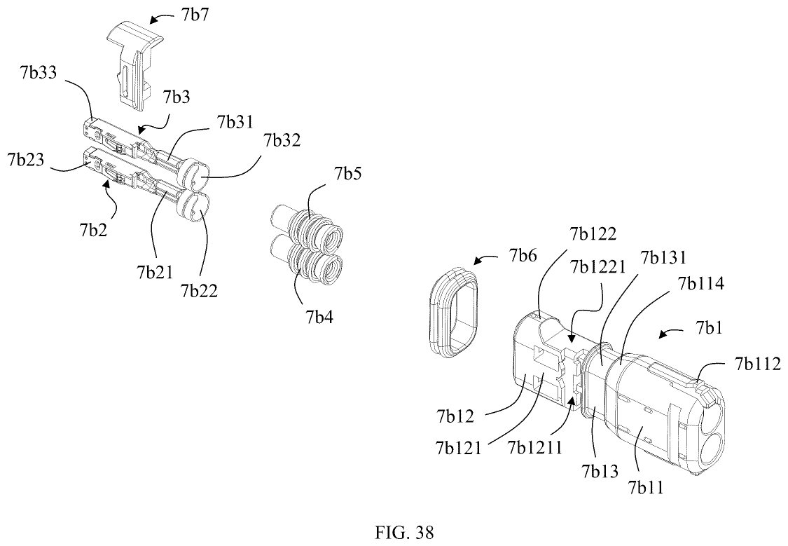

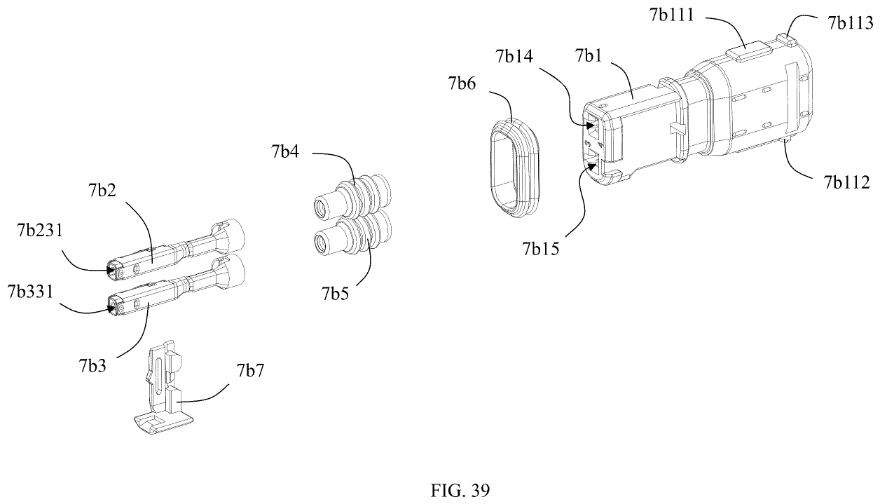

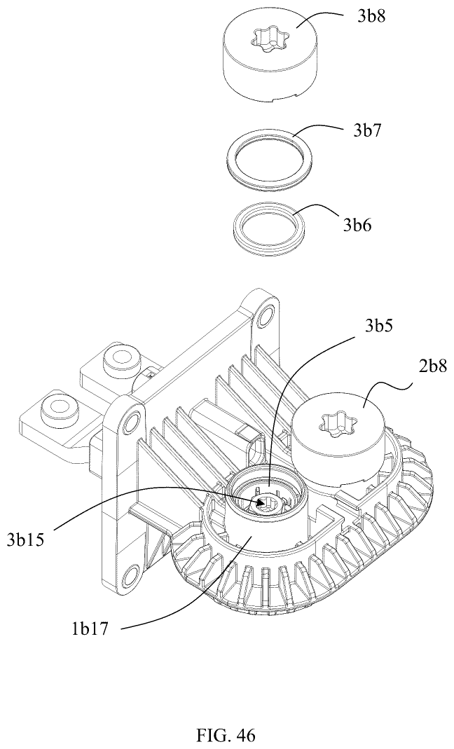

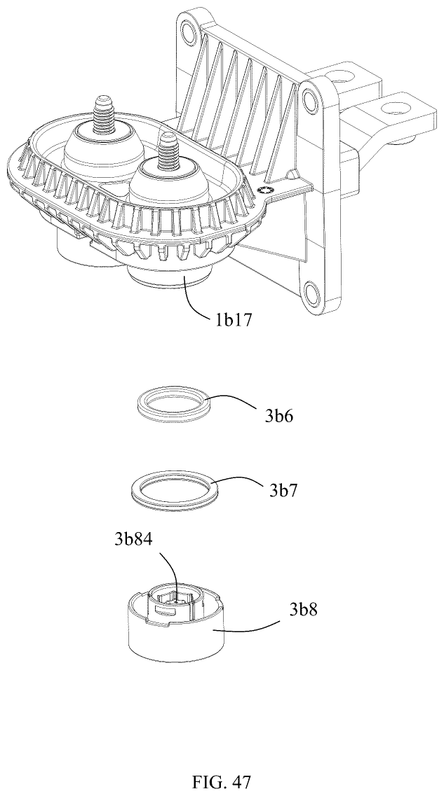

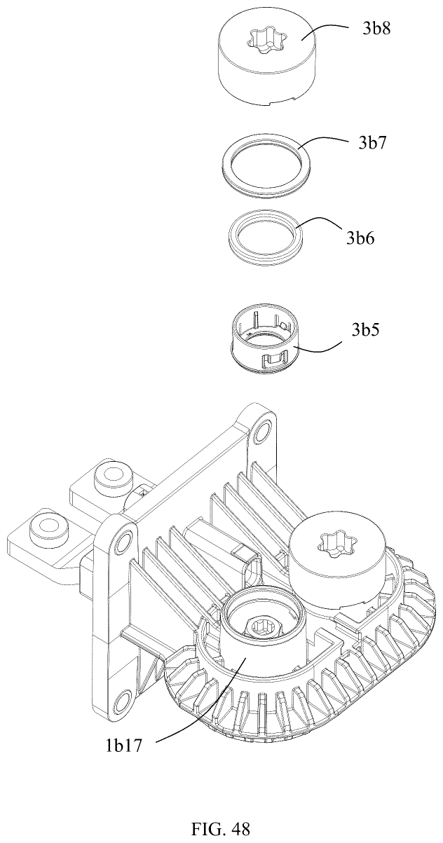

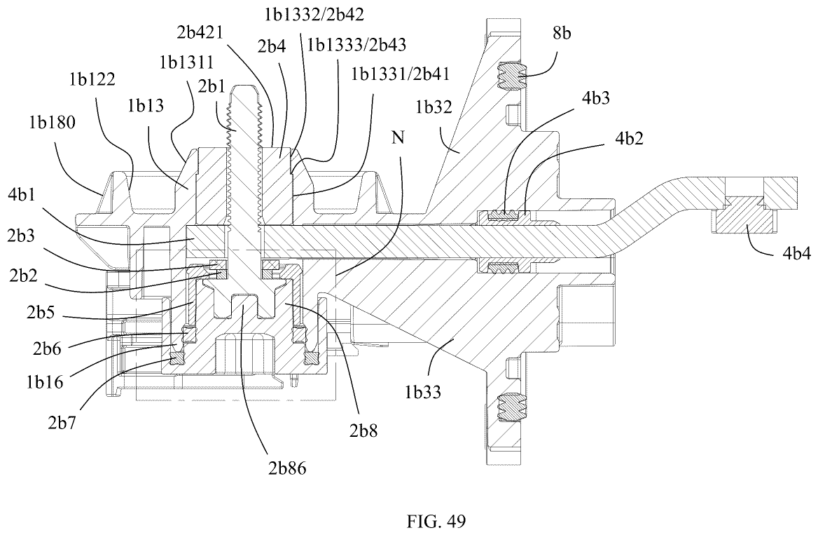

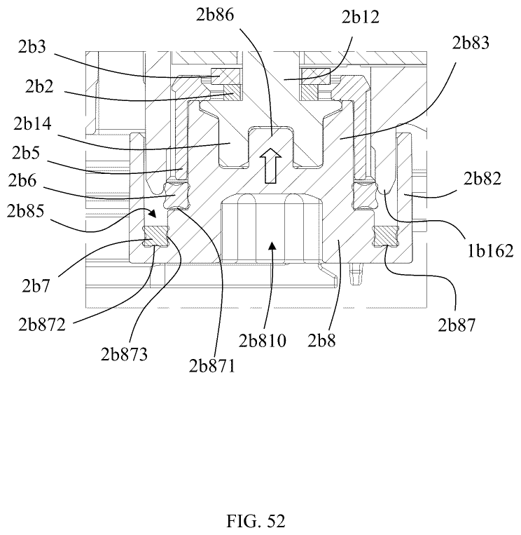

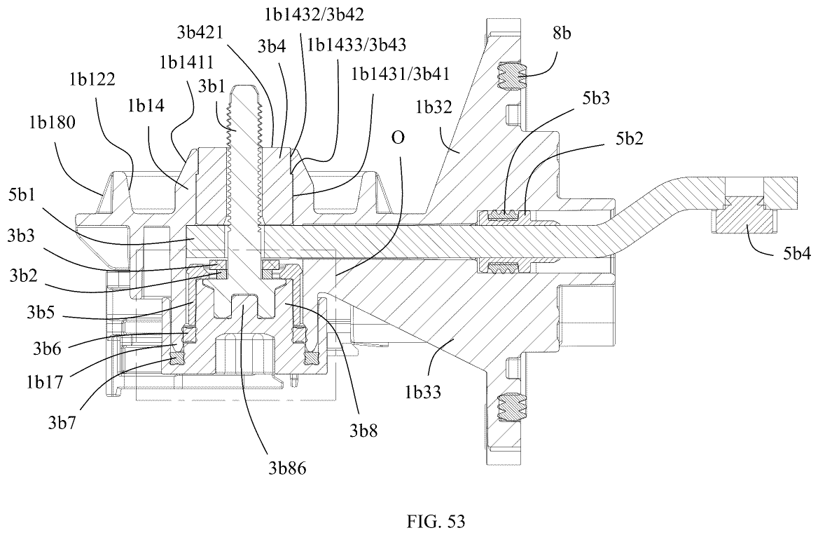

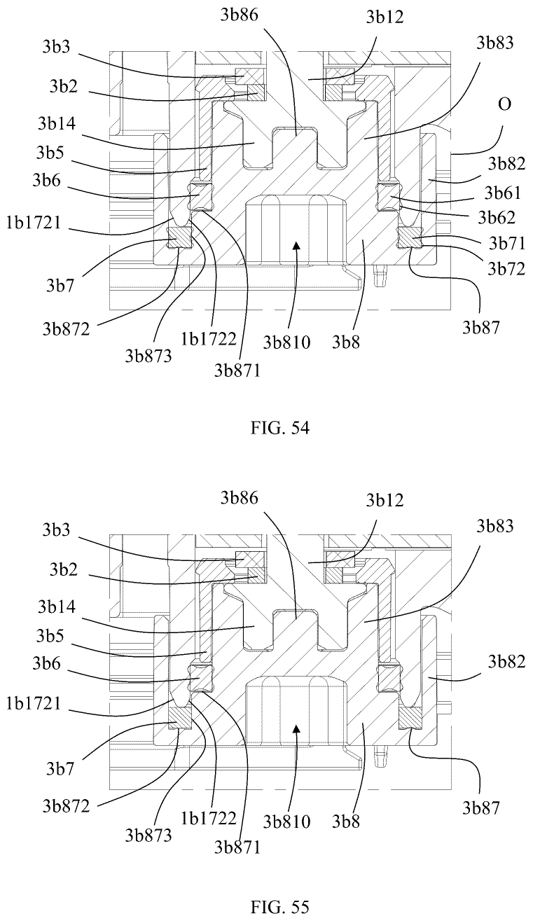

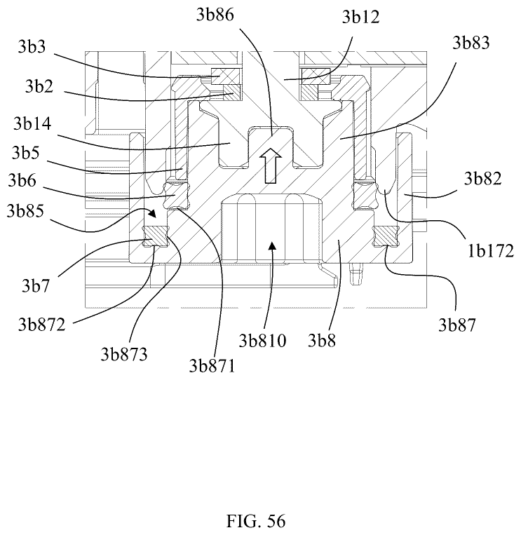

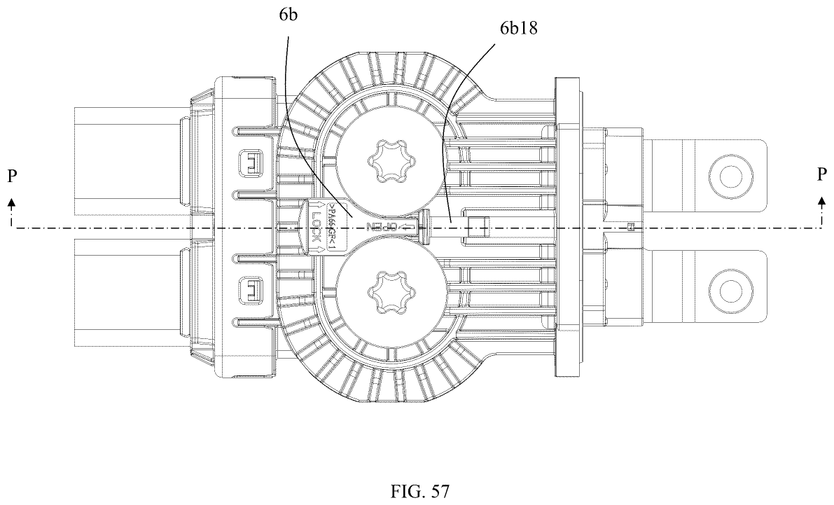

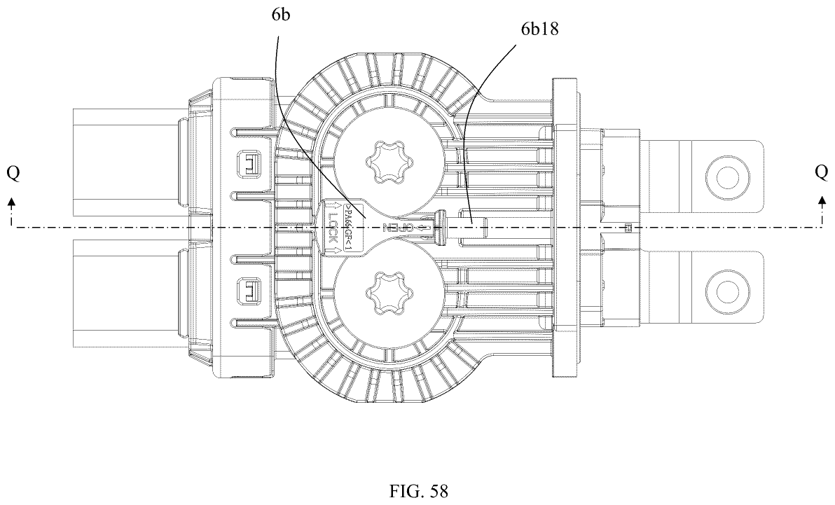

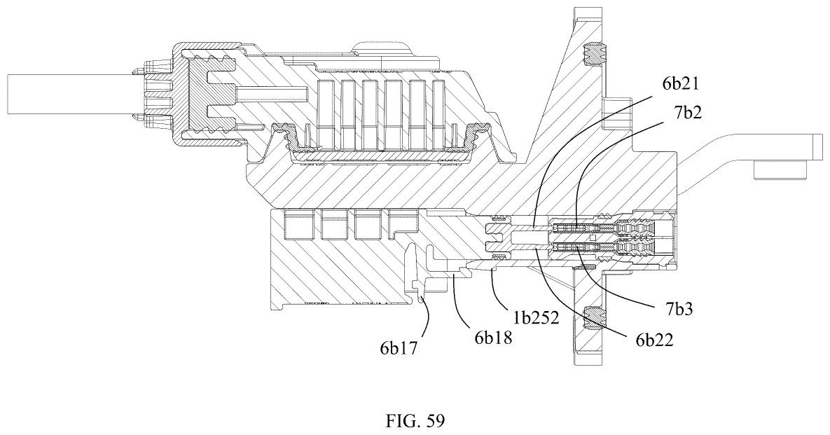

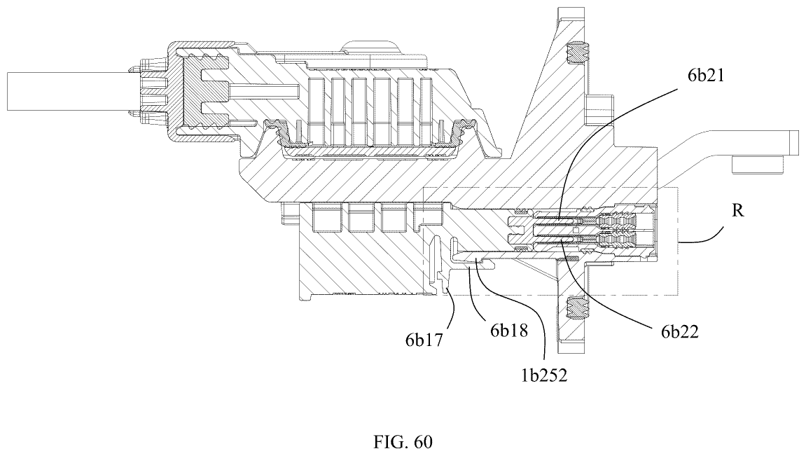

Referring to FIG. 24 to FIG. 56, the mating connector 200 includes a second housing 1b, a first terminal module 2b at least partially located in the second housing 1b, a second terminal module 3b at least partially located in the second housing 1b, a first connection conductive terminal module 4b connected to the first terminal module 2b, a second connection conductive terminal module 5b connected to the second terminal module 3b, a locking device 6b installed on the second housing 1b, an installation assembly 7b installed in the second housing 1b, and a third sealing ring 8b installed on the second housing 1b.

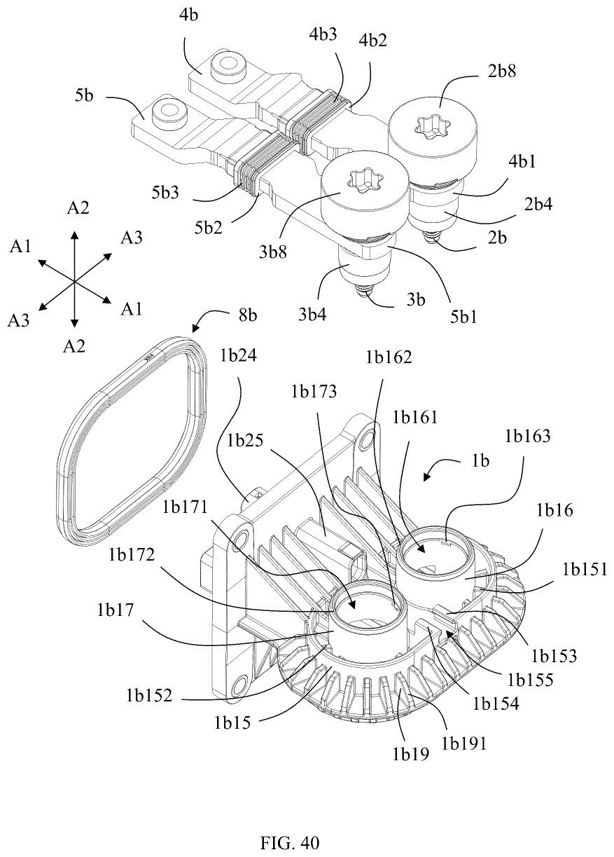

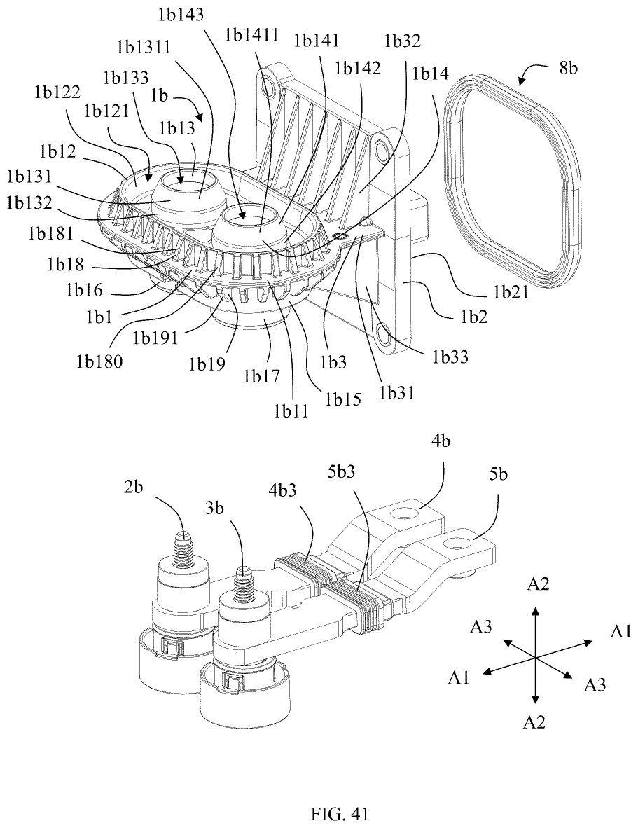

Referring to FIG. 40 and FIG. 41, in one embodiment of the present disclosure, the second housing 1b is made of insulating material, and includes a second main body portion 1b1, a second installation portion 1b2, and a connection portion 1b3 connecting the second main body portion 1b1 and the second installation portion 1b2. In the illustrated embodiment of the present disclosure, the second main body portion 1b1 extends generally horizontally, and the second installation portion 1b2 extends generally vertically. The connection portion 1b3 includes a connection plate 1b31 connecting the second main body portion 1b1 and the second installation portion 1b2 along the first direction A1-A1, a plurality of first reinforcing ribs 1b32 connecting the second main body portion 1b1 and the second installation portion 1b2 and spaced apart along the third direction A3-A3, and a plurality of second reinforcing ribs 1b33 connecting the second main body portion 1b1 and the second installation portion 1b2 and spaced apart along the third direction A3-A3. The first reinforcing ribs 1b32 and the second reinforcing ribs 1b33 are located on two sides of the connection plate 1b31, respectively, along the second direction A2-A2. The first reinforcing ribs 1b32 and the second reinforcing ribs 1b33 extend obliquely along the first direction A1-A1, but in different directions. By providing the first reinforcing ribs 1b32 and the second reinforcing ribs 1b33, the structural strength of the second housing 1b can be increased.

In the illustrated embodiment of the present disclosure, the second main body portion 1b1 includes a second base plate 1b11, a first protruding portion 1b12 protruding upwardly from the second base plate 1b11 along the second direction A2-A2, a first mating protruding portion 1b13 protruding upwardly from the second base plate 1b11 along the second direction A2-A2, a second mating protruding portion 1b14 protruding upwardly from the second base plate 1b11 along the second direction A2-A2, a second protruding portion 1b15 protruding downwardly from the second base plate 1b11 along the second direction A2-A2, a first mounting protrusion 1b16 protruding downwardly from the second base plate 1b11 along the second direction A2-A2, and a second mounting protruding portion 1b17 protruding downwardly from the second base plate 1b11 along the second direction A2-A2.

In the illustrated embodiment of the present disclosure, the first protruding portion 1b12 is provided with a first receiving space 1b121, and a first mating conical surface 1b122 located on an inner side of the first protruding portion 1b12 and exposed in the first receiving space 1b121. In the illustrated embodiment of the present disclosure, the first mating conical surface 1b122 is configured to match the first conical surface 1a177 to facilitate mating.

In the illustrated embodiment of the present disclosure, the first mating protruding portion 1b13 and the second mating protruding portion 1b14 are spaced apart along the third direction A3-A3. The first protruding portion 1b12 is disposed around a periphery of the first mating protruding portion 1b13 and the second mating protruding portion 1b14. In other words, the first mating protruding portion 1b13 and the second mating protruding portion 1b14 are both located in the first receiving space 1b121. In the illustrated embodiment of the present disclosure, the first protruding portion 1b12, the first mating protruding portion 1b13 and the second mating protruding portion 1b14 are integrally formed. In addition, in the illustrated embodiment of the present disclosure, the second main body portion 1b1 further includes at least one first connection block 1b18 connecting the first protruding portion 1b12 and the second base plate 1b11. The first connection block 1b18 is provided with an inclined first guiding surface 1b181. In the illustrated embodiment of the present disclosure, a plurality of first connection block 1b18 are provided and spaced apart along a circumference of the first protruding portion 1b12. The first guiding surfaces 1b181 together form a guiding conical surface 1b180 to match the second conical surface 1a311 of the first conical portion 1a31 of the electrical connector 100, thereby facilitating automatic alignment and improving the uniformity of stress distribution. At the same time, the first connection block 1b18 can also increase the structural strength of the second housing 1b.

The first mating protruding portion 1b13 is provided with a first mating conical portion 1b131 at a top thereof, a first mating cylindrical portion 1b132 at a bottom thereof, and a first assembly hole 1b133 extending through the first mating conical portion 1b131 and the first mating cylindrical portion 1b132 along the second direction A2-A2. The first mating conical portion 1b131 is provided with a first mating conical surface 1b1311 on an outer side thereof. The first mating conical surface 1b1311 is configured to cooperate with the first sleeve portion 7a2 of the electrical connector 100 to facilitate automatic alignment and insertion of the first mating protruding portion 1b13 into the first sleeve portion 7a2. In the illustrated embodiment of the present disclosure, the first assembly hole 1b133 is a stepped hole, including a first cylindrical hole 1b1331 at a lower portion and a second cylindrical hole 1b1332 at an upper portion connected to the first cylindrical hole 1b1331. In the illustrated embodiment of the present disclosure, a diameter of the first cylindrical hole 1b1331 is greater than a diameter of the second cylindrical hole 1b1332. The first cylindrical hole 1b1331 extends through the first mating cylindrical portion 1b132 along the second direction A2-A2. The second cylindrical hole 1b1332 extends upwardly through the first mating conical portion 1b131 along the second direction A2-A2. The first mating protruding portion 1b13 is provided with a first stepped surface 1b1333 at a junction of the first cylindrical hole 1b1331 and the second cylindrical hole 1b1332.

Similarly, the second mating protruding portion 1b14 is provided with a second mating conical portion 1b141 at a top thereof, a second mating cylindrical portion 1b142 at a bottom thereof, and a second assembly hole 1b143 extending through the second mating conical portion 1b141 and the second mating cylindrical portion 1b142 along the second direction A2-A2. The second mating conical portion 1b141 is provided with a second mating conical surface 1b1411 on an outer side thereof. The second mating conical surface 1b1411 is configured to mate with the second sleeve portion 7a3 of the electrical connector 100 to facilitate automatic alignment and insertion of the second mating protruding portion 1b14 into the second sleeve portion 7a3. In the illustrated embodiment of the present disclosure, the second assembly hole 1b143 is a stepped hole, including a third cylindrical hole 1b1431 at a lower portion and a fourth cylindrical hole 1b1432 at an upper portion connected to the third cylindrical hole 1b1431. In the illustrated embodiment of the present disclosure, a diameter of the third cylindrical hole 1b1431 is greater than a diameter of the fourth cylindrical hole 1b1432. The third cylindrical hole 1b1431 extends through the second mating cylindrical portion 1b142 along the second direction A2-A2. The fourth cylindrical hole 1b1432 extends upwardly through the second mating conical portion 1b141 along the second direction A2-A2. The second mating protruding portion 1b14 is provided with a second stepped surface 1b1433 at a junction of the third cylindrical hole 1b1431 and the fourth cylindrical hole 1b1432.

In the illustrated embodiment of the present disclosure, the second main body portion 1b1 is further provided with a plurality of second connection blocks 1b19 connecting the second protruding portion 1b15 and the second base plate 1b11. In the illustrated embodiment of the present disclosure, the second connection blocks 1b19 are spaced apart along a circumference of the second protruding portion 1b15. The second connection blocks 1b19 can increase the structural strength of the second housing 1b. In addition, each second connection block 1b19 is provided with an inclined second guiding surface 1b191. The second guiding surface 1b191 is beneficial for reflecting foreign objects that may collide with a bottom of the second main body portion 1b1, thereby reducing the risk of damage to the second main body portion 1b1 and improving reliability.

In the illustrated embodiment of the present disclosure, the second main body portion 1b1 is further provided with a plurality of first connection ribs 1b151 connecting the second protruding portion 1b15 and the first mounting protrusion 1b16, and a plurality of second connection ribs 1b152 connecting the second protruding portion 1b15 and the second mounting protruding portion 1b17. In the illustrated embodiment of the present disclosure, the plurality of first connection ribs 1b151 are arranged in a radial pattern and connected to the second base plate 1b11. The plurality of second connection ribs 1b152 are arranged in a radial pattern and connected to the second base plate 1b11.

In addition, in the illustrated embodiment of the present disclosure, the second protruding portion 1b15 is further provided with a first side wall 1b153, a second side wall 1b154, a receiving slot 1b155 located between the first side wall 1b153 and the second side wall 1b154 along the third direction A3-A3, and a receiving space 1b156 located in front of the receiving slot 1b155 along the first direction A1-A1. The first side wall 1b153 and the second side wall 1b154 both extend along the first direction A1-A1. The first side wall 1b153 and the second side wall 1b154 are spaced apart along the third direction A3-A3. The first side wall 1b153 is provided with a first installation guide groove 1b1531 communicating with the receiving slot 1b155, and a first stop surface 1b1532 located at a rear end of the first installation guide groove 1b1531. Similarly, the second side wall 1b154 is provided with a second mounting guide groove 1b1541 communicating with the receiving slot 1b155, and a second stop surface 1b1542 located at a rear end of the second mounting guide groove 1b1541. The first stop surface 1b1532 and the second stop surface 1b1542 are both exposed forwardly in the receiving space 1b156. The first mounting protrusion 1b16 and the second mounting protruding portion 1b17 are located on two sides of the receiving space 1b156, respectively, along the third direction A3-A3.

In the illustrated embodiment of the present disclosure, the first mounting protrusion 1b16 is cylindrical, and includes a first mounting space 1b161, a first edge portion 1b162 located at a bottom edge of the first mounting protrusion 1b16, and a plurality of first locking protrusions 1b163 protruding inwardly into the first mounting space 1b161. The first edge portion 1b162 includes a first inclined guiding surface 1b1621 on an outer side thereof and a second inclined guiding surface 1b1622 on an inner side thereof.

In the illustrated embodiment of the present disclosure, the second mounting protruding portion 1b17 is cylindrical, and includes a second mounting space 1b171, a second edge portion 1b172 located at a bottom edge of the second mounting protruding portion 1b17, and a plurality of second locking protrusions 1b173 protruding inwardly into the second mounting space 1b171. The second edge portion 1b172 includes a third inclined guiding surface 1b1721 on an outer side thereof and a fourth inclined guiding surface 1b1722 on an inner side thereof.

The second installation portion 1b2 includes a mounting wall 1b21, a first mounting frame portion 1b22 extending forwardly from the mounting wall 1b21 along the first direction A1-A1, a second mounting frame portion 1b23 extending forwardly from the mounting wall 1b21 along the first direction A1-A1, a first installation extension 1b24 extending forwardly from the mounting wall 1b21 along the first direction A1-A1, and a second installation extension 1b25 extending backwardly from the mounting wall 1b21 along the first direction A1-A1. In one embodiment of the present disclosure, the first mounting frame portion 1b22, the second mounting frame portion 1b23, the first installation extension 1b24 and the second installation extension 1b25 are all integrally formed with the mounting wall 1b21. The third sealing ring 8b is installed on the mounting wall 1b21 and surrounds a periphery of the first mounting frame portion 1b22, the second mounting frame portion 1b23, and the first installation extension 1b24.

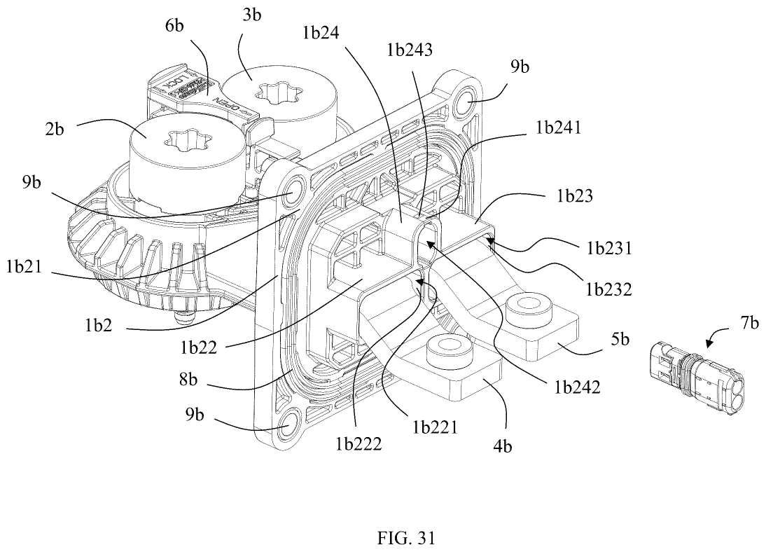

Referring to FIG. 31, in the illustrated embodiment of the present disclosure, the mating connector 200 also includes a plurality of screw fixing sleeves 9b fixed to the mounting wall 1b21. In the illustrated embodiment of the present disclosure, four screw fixing sleeves 9b are provided, and embedded and fixed at four corners of the mounting wall 1b21. Preferably, the screw fixing sleeves 9b are made of metal to improve structural strength.

The first mounting frame portion 1b22 is provided with a first mounting cavity 1b221 and a first annular inner wall surface 1b222 exposed in the first mounting cavity 1b221.

The second mounting frame portion 1b23 is provided with a second mounting cavity 1b231 and a second annular inner wall surface 1b232 exposed in the second mounting cavity 1b231.

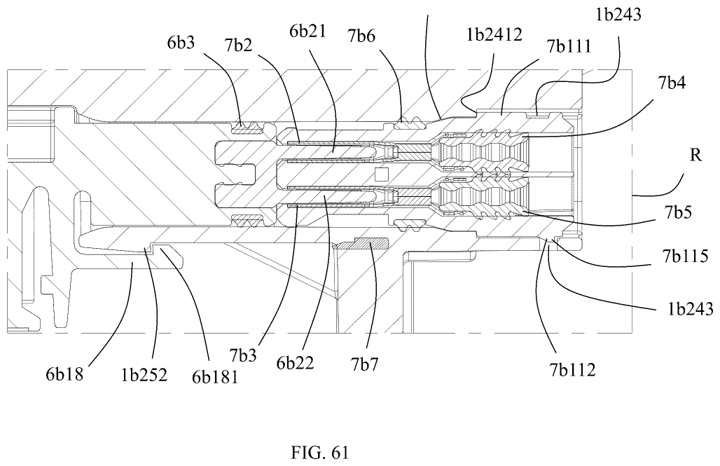

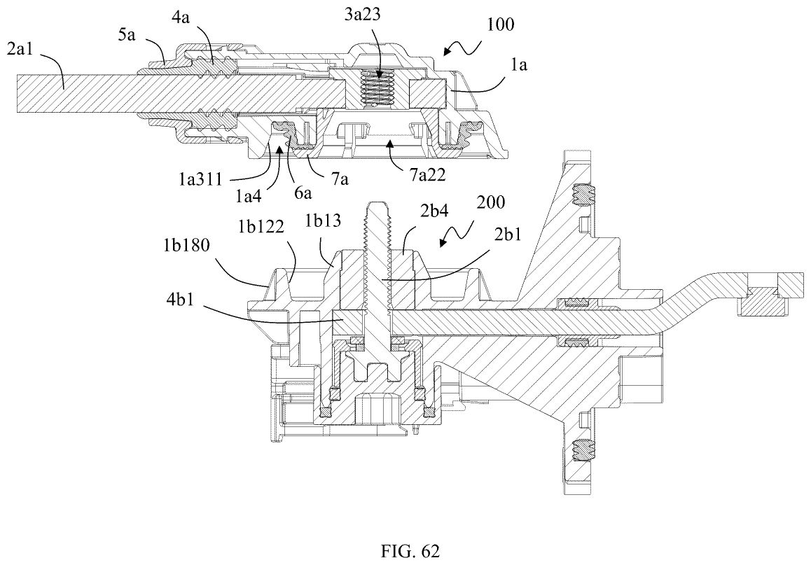

The first installation extension 1b24 is provided with a first annular wall portion 1b241 and a first assembly space 1b242 surrounded by the first annular wall portion 1b241. In the illustrated embodiment of the present disclosure, the first annular wall portion 1b241 is integrally connected with the first mounting frame portion 1b22 and the second mounting frame portion 1b23. The first annular wall portion 1b241 is further provided with at least one locking hole 1b243 communicating with the first assembly space 1b242. Referring to FIG. 61, an inner wall of the first annular wall portion 1b241 is provided with a guiding conical surface 1b2411 and a limiting wall surface 1b2412 exposed in the first assembly space 1b242.

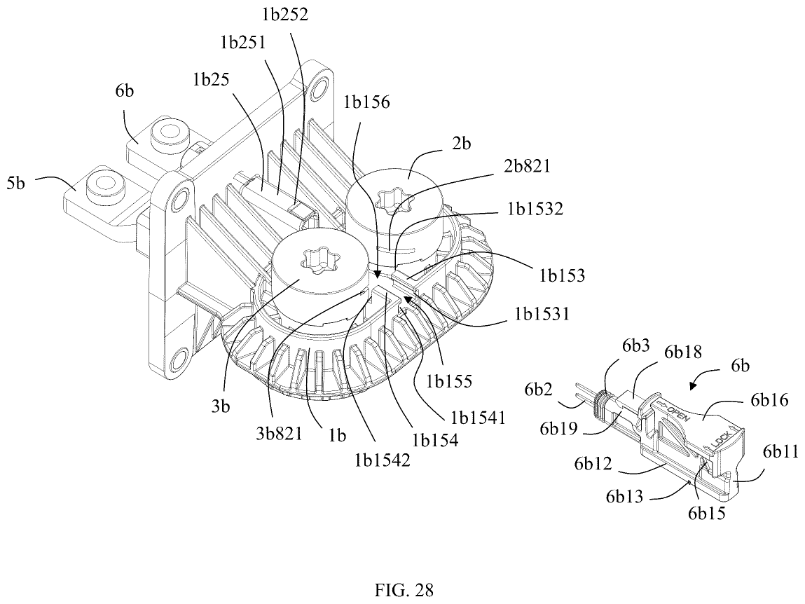

Referring to FIG. 28, in the illustrated embodiment of the present disclosure, the second installation extension 1b25 includes a second annular wall portion 1b251. The first assembly space 1b242 further extends along the first direction A1-A1 and extends through the second installation extension 1b25. In the illustrated embodiment of the present disclosure, the second installation extension 1b25 further includes a protrusion 1b252 protruding from the second annular wall portion 1b251 along the second direction A2-A2.

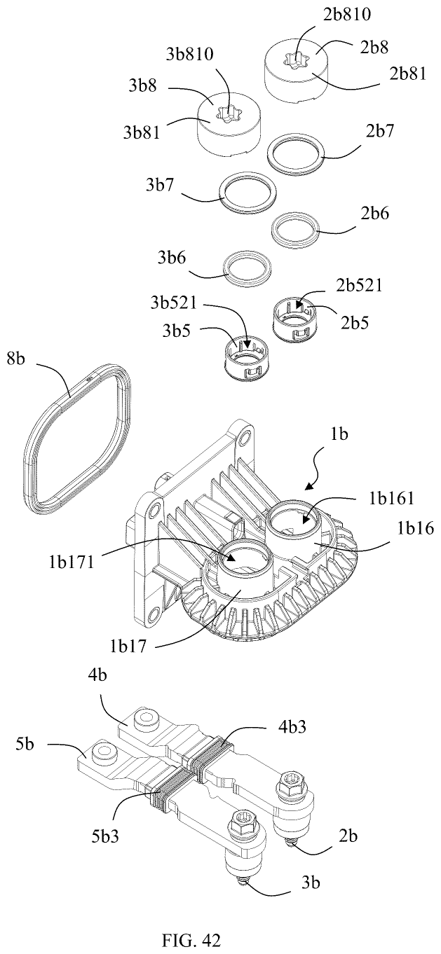

Referring to FIG. 42 to FIG. 45, the first terminal module 2b includes a first mating terminal 2b1, a first elastic washer 2b2, a first flat washer 2b3, a first adapter sleeve 2b4 installed in the first mating protruding portion 1b13, a first retaining sleeve 2b5 fixed in the first mounting space 1b161 of the first mounting protrusion 1b16, a first mating sealing ring 2b6 mating with the first retaining sleeve 2b5, a second mating sealing ring 2b7 mating with the first mounting protrusion 1b16, and a first rotating cover 2b8 mating with the first mating terminal 2b1. The first retaining sleeve 2b5 abuts against the first locking protrusions 1b163 to prevent the first retaining sleeve 2b5 from falling out of the first mounting space 1b161.

In the illustrated embodiment of the present disclosure, the first mating terminal 2b1 includes a first abutting portion 2b11, a first assembly portion 2b12 connected to the first abutting portion 2b11 along the second direction A2-A2, a first mating portion 2b13 protruding beyond the first assembly portion 2b12 along the second direction A2-A2 and connected to the first assembly portion 2b12, and a first force-receiving portion 2b14 protruding beyond the first abutting portion 2b11 along the second direction A2-A2. In the illustrated embodiment of the present disclosure, the first mating portion 2b13 is provided with a first mating thread 2b131. The first mating thread 2b131 mates with the first terminal mating hole 2a23. In one embodiment of the present disclosure, the first mating thread 2b131 is threadedly engaged with the first terminal mating hole 2a23. When a first threaded sleeve 2a3 is provided in the first terminal mating hole 2a23, the first mating thread 2b131 is threadedly engaged with the first threaded sleeve 2a3 to improve contact reliability. In the illustrated embodiment of the present disclosure, the first force-receiving portion 2b14 is a hexagonal nut, and the bottom of the first force-receiving portion 2b14 is provided with a first mating hole 2b15 that extends through the first force-receiving portion 2b14 along the second direction A2-A2. In the illustrated embodiment of the present disclosure, the first mating hole 2b15 is a spline hole to have a specific shape. In one embodiment of the present disclosure, the first mating terminal 2b1 is made of stainless steel.

The first elastic washer 2b2 is sleeved on the first assembly portion 2b12. In the illustrated embodiment of the present disclosure, the first elastic washer 2b2 is provided with a first slit 2b21 to facilitate adjusting the thickness of the first elastic washer 2b2 in the second direction A2-A2. In one embodiment of the present disclosure, the first elastic washer 2b2 is made of metal. When the first elastic washer 2b2 is not pressed by the first abutting portion 2b11, the first elastic washer 2b2 is in a warped state to apply a certain force to the first mating terminal 2b1. When the first elastic washer 2b2 is pressed in place by the first abutting portion 2b11, the first elastic washer 2b2 is substantially flat.

The first flat washer 2b3 is sleeved on the first assembly portion 2b12. The first flat washer 2b3 is located above the first elastic washer 2b2 along the second direction A2-A2 and abuts against the first elastic washer 2b2. In one embodiment of the present disclosure, the first flat washer 2b3 is made of metal. The first flat washer 2b3 is always in a flat state.

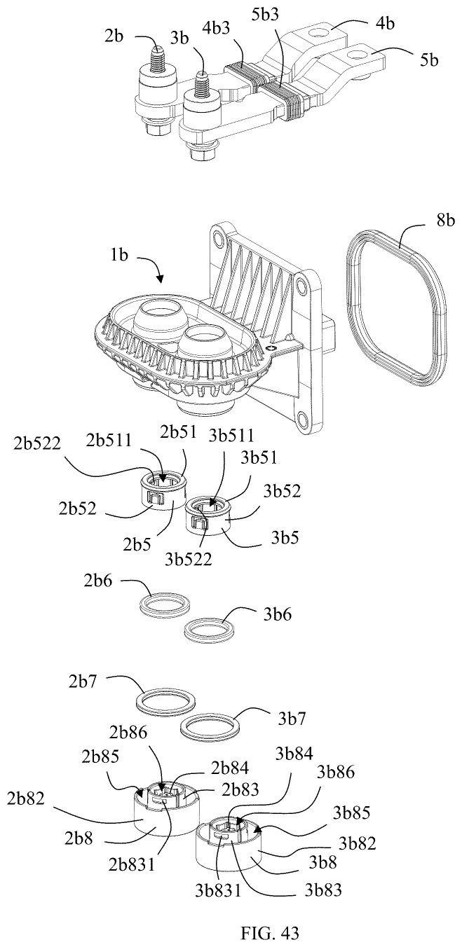

Referring to FIG. 42 and FIG. 43, the first rotating cover 2b8 is made of an insulating material (for example, nylon), and includes a first cover body 2b81, a first annular outer wall portion 2b82 protruding upwardly from the first cover body 2b81, a first annular inner wall portion 2b83 protruding upwardly from the first cover body 2b81, a first force-applying protrusion 2b84 protruding upwardly from the first cover body 2b81, a first annular accommodating groove 2b85 located between the first annular inner wall portion 2b83 and the first annular outer wall portion 2b82, and a first annular recessed groove 2b86 located between the first annular inner wall portion 2b83 and the first force-applying protrusion 2b84.

In the illustrated embodiment of the present disclosure, the first annular outer wall portion 2b82, the first annular inner wall portion 2b83, and the first force-applying protrusion 2b84 are integrally formed with the first cover body 2b81. The first cover body 2b81 defines a first spline slot 2b810. The first annular outer wall portion 2b82 defines a first slot 2b821.

In the illustrated embodiment of the present disclosure, the first annular inner wall portion 2b83 protrudes upwardly from the first annular outer wall portion 2b82 along the second direction A2-A2, and the first annular inner wall portion 2b83 protrudes upwardly from the first force-applying protrusion 2b84 along the second direction A2-A2. The first annular inner wall portion 2b83 defines a first retaining slot 2b831. The first force-applying protrusion 2b84 is secured in the first engagement hole 2b15. In the illustrated embodiment of the present disclosure, the first force-applying protrusion 2b84 has an outer side surface shaped like a spline to match the shape of the first engagement hole 2b15.

The first rotating cover 2b8 is retained on the first retaining sleeve 2b5 and/or the first mounting protrusion 1b16 to prevent the first rotating cover 2b8 from falling off. In the illustrated embodiment of the present disclosure, the first retaining sleeve 2b5 includes a first top wall 2b51 and a first annular wall 2b52 extending integrally and downwardly from a periphery of the first top wall 2b51 along the second direction A2-A2. The first top wall 2b51 defines a first opening 2b511 in which the first elastic washer 2b2 is at least partially located. The first annular wall 2b52 is provided with a first internal space 2b521 and at least one first retaining protrusion 2b522 protruding inwardly into the first internal space 2b521. The first retaining protrusion 2b522 is locked in the first retaining slot 2b831 to prevent the first rotating cover 2b8 from detaching downwardly from the first retaining sleeve 2b5 along the second direction A2-A2.

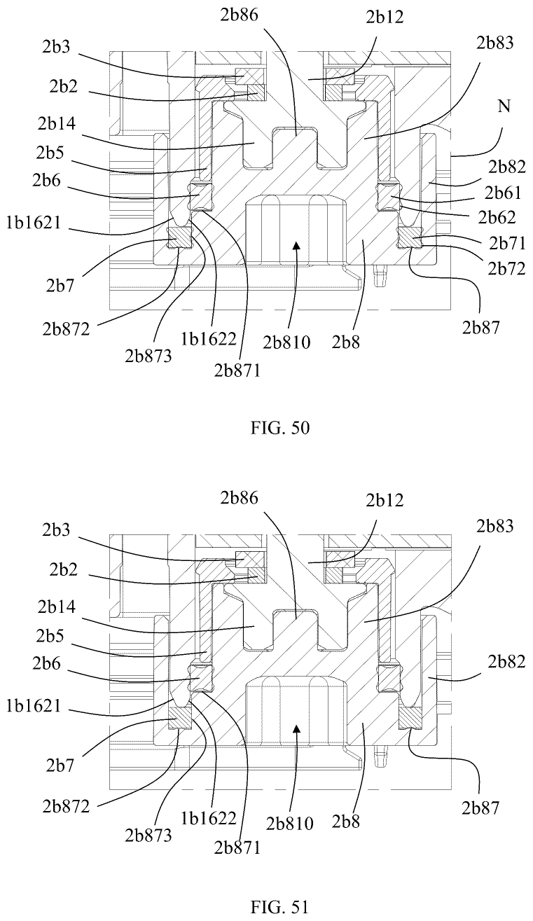

Besides, in the illustrated embodiment of the present disclosure, the first cover body 2b81 of the first rotating cover 2b8 further includes a first stepped surface 2b87 exposed in the first annular accommodating groove 2b85 (as shown in FIG. 50). In the illustrated embodiment of the present disclosure, the first stepped surface 2b87 includes a first bottom surface 2b871, a second bottom surface 2b872 located lower than the first bottom surface 2b871, and a first connecting surface 2b873 connecting the first bottom surface 2b871 and the second bottom surface 2b872.

Referring to FIG. 50, the first mating sealing ring 2b6 is sleeved on the first annular inner wall portion 2b83, and located at a bottom of the first annular inner wall portion 2b83, with its bottom surface abutting against the first bottom surface 2b871. A cross-sectional shape of the first mating sealing ring 2b6 may be star-shaped or other shapes. In the description of the present disclosure, the star-shaped cross-section of the first mating sealing ring 2b6 means that the cross-section of the first mating sealing ring 2b6 includes a first base portion 2b61, and a plurality of first abutting protrusions 2b62 integrally extending from and protruding from the first base portion 2b61, with the plurality of first abutting protrusions 2b62 distributed circumferentially around the first base portion 2b61. In one embodiment of the present disclosure, the first base portion 2b61 is substantially rectangular, and the plurality of first abutting protrusions 2b62 are uniformly distributed circumferentially around the first base portion 2b61. The first abutting protrusions 2b62 are configured to abut against corresponding wall surfaces to achieve sealing. In the illustrated embodiment of the present disclosure, four first abutting protrusions 2b62 are provided. Of course, it is understandable to those skilled in the art that the number of the first abutting protrusions 2b62 can be flexibly adjusted as needed. In one embodiment of the present disclosure, the first mating sealing ring 2b6 is made of silicone rubber.

The second mating sealing ring 2b7 is sleeved on the first connecting surface 2b873 and located at a bottom of the first annular accommodating groove 2b85, with its bottom surface abutting against the second bottom surface 2b872. A cross-sectional shape of the second mating sealing ring 2b7 may be star-shaped, rectangular, or other shapes. In the description of the present disclosure, the star-shaped cross-section of the second mating sealing ring 2b7 means that the cross-section of the second mating sealing ring 2b7 includes a second base portion 2b71, and a plurality of second abutting protrusions 2b72 integrally extending from and protruding from the second base portion 2b71, with the plurality of second abutting protrusions 2b72 distributed circumferentially around the second base portion 2b71. In one embodiment of the present disclosure, the second base portion 2b71 is substantially rectangular, and the plurality of second abutting protrusions 2b72 are uniformly distributed circumferentially around the second base portion 2b71. The second abutting protrusions 2b72 are configured to abut against corresponding wall surfaces to achieve sealing. In the illustrated embodiment of the present disclosure, four second abutting protrusions 2b72 are provided. Of course, it is understandable to those skilled in the art that the number of the second abutting protrusions 2b72 can be flexibly adjusted as needed. In one embodiment of the present disclosure, the second mating sealing ring 2b7 is made of silicone rubber. In one embodiment of the present disclosure, the second mating sealing ring 2b7 is a regular annular shape. In another embodiment of the present disclosure, the second mating sealing ring 2b7 is an irregular annular shape, with a plurality of outwardly protruding protrusions (not shown) provided on the second mating sealing ring 2b7, and the plurality of protrusions are uniformly distributed circumferentially on the second mating sealing ring 2b7.

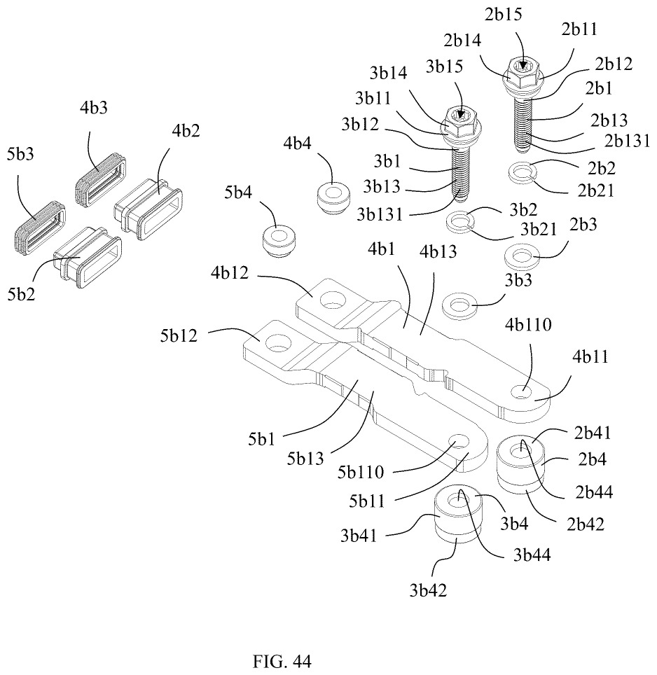

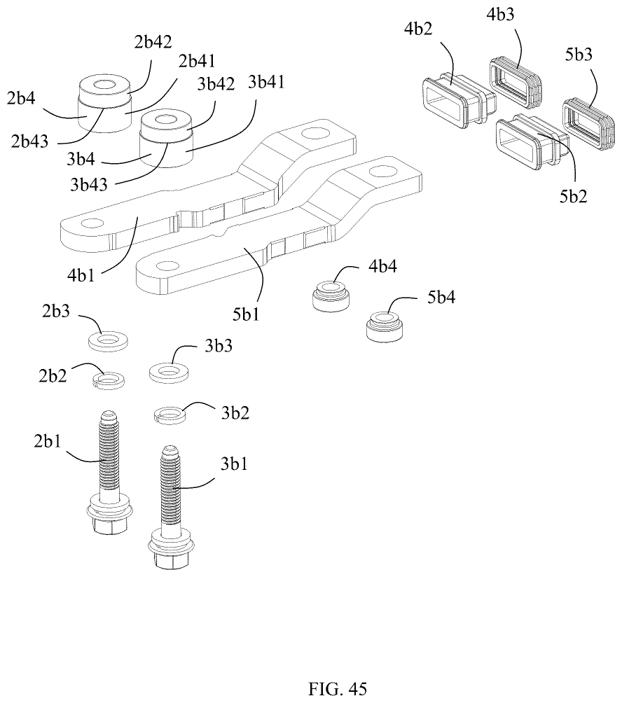

Referring to FIG. 44 and FIG. 45, the first adapter sleeve 2b4 is accommodated in the first assembly hole 1b133. In one embodiment of the present disclosure, the first adapter sleeve 2b4 is made of metal (for example, copper). The first adapter sleeve 2b4 includes a first cylindrical portion 2b41, a second cylindrical portion 2b42, a first abutting surface 2b43 connecting the first cylindrical portion 2b41 and the second cylindrical portion 2b42, and a first mounting through-hole 2b44 extending through the first cylindrical portion 2b41 and the second cylindrical portion 2b42 along the second direction A2-A2. In the illustrated embodiment of the present disclosure, a diameter of the first cylindrical portion 2b41 is greater than a diameter of the second cylindrical portion 2b42. The first cylindrical portion 2b41 is accommodated in the first cylindrical hole 1b1331, the second cylindrical portion 2b42 is accommodated in the second cylindrical hole 1b1332, and the first abutting surface 2b43 abuts against the first stepped surface 1b1333. In the illustrated embodiment of the present disclosure, the second cylindrical portion 2b42 is provided with a third exposed surface 2b421 exposed to the first mating protrusion 1b13. The third exposed surface 2b421 contacts the first exposed surface 2a221 to improve protective performance.

The second terminal module 3b includes a second mating terminal 3b1, a second elastic washer 3b2, a second flat washer 3b3, a second adapter sleeve 3b4 installed in the second mating protrusion 1b14, a second retaining sleeve 3b5 installed and fixed in the second mounting space 1b171 of the second mounting protrusion 1b17, a third mating sealing ring 3b6 mating with the second retaining sleeve 3b5, a fourth mating sealing ring 3b7 mating with the second mounting protrusion 1b17, and a second rotating cover 3b8 mating with the second mating terminal 3b1. The second retaining sleeve 3b5 abuts against the second locking protrusion 1b173 to prevent the second retaining sleeve 3b5 from detaching from the second mounting space 1b171. In one embodiment of the present disclosure, the third mating sealing ring 3b6 and the fourth mating sealing ring 3b7 are both made of silicone rubber.

In the illustrated embodiment of the present disclosure, the second mating terminal 3b1 includes a second abutting portion 3b11, a second assembly portion 3b12 connected upwardly to the second abutting portion 3b11 along the second direction A2-A2, a second mating portion 3b13 protruding upwardly from the second assembly portion 3b12 along the second direction A2-A2 and connected to the second assembly portion 3b12, and a second force-bearing portion 3b14 protruding downwardly from the second abutting portion 3b11 along the second direction A2-A2. In the illustrated embodiment of the present disclosure, the second mating portion 3b13 is provided with a second mating thread 3b131. The second mating thread 3b131 mates with the second terminal mating hole 3a23. In one embodiment of the present disclosure, the second mating thread 3b131 is threadedly engaged with the second terminal mating hole 3a23. When a second thread sleeve 3a3 is provided in the second terminal mating hole 3a23, the second mating thread 3b131 is threadedly engaged with the second thread sleeve 3a3 to improve contact reliability. In the illustrated embodiment of the present disclosure, the second force-bearing portion 3b14 is a hexagonal nut, and the bottom of the second force-bearing portion 3b14 is provided with a second engagement hole 3b15 extending through the second force-bearing portion 3b14 along the second direction A2-A2. In the illustrated embodiment of the present disclosure, the second engagement hole 3b15 is a spline hole to achieve a specific shape. In one embodiment of the present disclosure, the second mating terminal 3b1 is made of stainless steel.

The second elastic washer 3b2 is sleeved on the second assembly portion 3b12. In the illustrated embodiment of the present disclosure, the second elastic washer 3b2 defines a second slit 3b21 to facilitate adjusting the thickness of the second elastic washer 3b2 along the second direction A2-A2. In one embodiment of the present disclosure, the second elastic washer 3b2 is made of metal. When the second elastic washer 3b2 is not pressed by the second abutting portion 3b11, the second elastic washer 3b2 is in a warped state to apply a certain force to the second mating terminal 3b1. When the second elastic washer 3b2 is pressed into place by the second abutting portion 3b11, the second elastic washer 3b2 is substantially flat.

The second flat washer 3b3 is sleeved on the second assembly portion 3b12. The second flat washer 3b3 is located above the second elastic washer 3b2 along the second direction A2-A2 and abuts against the second elastic washer 3b2. In one embodiment of the present disclosure, the second flat washer 3b3 is made of metal. The second flat washer 3b3 is always in a flat state.

The second rotating cover 3b8 is made of an insulating material (for example, nylon), and includes a second cover body 3b81, a second annular outer wall portion 3b82 protruding upwardly from the second cover body 3b81, a second annular inner wall portion 3b83 protruding upwardly from the second cover body 3b81, a second force-applying protrusion 3b84 protruding upwardly from the second cover body 3b81, a second annular accommodating groove 3b85 located between the second annular inner wall portion 3b83 and the second annular outer wall portion 3b82, and a second annular recessed groove 3b86 located between the second annular inner wall portion 3b83 and the second force-applying protrusion 3b84.

In the illustrated embodiment of the present disclosure, the second annular outer wall portion 3b82, the second annular inner wall portion 3b83 and the second force-applying protrusion 3b84 are integrally formed with the second cover body 3b81. The second cover body 3b81 defines a second spline slot 3b810. The second annular outer wall portion 3b82 defines a second locking groove 3b821.

In the illustrated embodiment of the present disclosure, the second annular inner wall portion 3b83 protrudes upwardly beyond the second annular outer wall portion 3b82 along the second direction A2-A2. The second annular inner wall portion 3b83 protrudes upwardly beyond the second force-applying protrusion 3b84 along the second direction A2-A2. The second annular inner wall portion 3b83 defines a second retaining slot 3b831. The second force-applying protrusion 3b84 is fixed in the second engagement hole 3b15. In the illustrated embodiment of the present disclosure, the second force-applying protrusion 3b84 has an outer side surface shaped like a spline to match the shape of the second engagement hole 3b15.

The second rotating cover 3b8 is retained on the second retaining sleeve 3b5 and/or the second mounting protruding portion 1b17 to prevent the second rotating cover 3b8 from falling off. In the illustrated embodiment of the present disclosure, the second retaining sleeve 3b5 includes a second top wall 3b51, and a second annular wall 3b52 extending integrally and downwardly from the periphery of the second top wall 3b51 along the second direction A2-A2. The second top wall 3b51 is provided with a second opening 3b511, and the second elastic washer 3b2 is at least partially located in the second opening 3b511. The second annular wall 3b52 is provided with a second internal space 3b521 and at least one second retaining protrusion 3b522 protruding inward into the second internal space 3b521. The second retaining protrusion 3b522 is locked with the second retaining slot 3b831 to prevent the second rotating cover 3b8 from detaching downward from the second retaining sleeve 3b5 along the second direction A2-A2.

Besides, in the illustrated embodiment of the present disclosure, the second cover body 3b81 of the second rotating cover 3b8 further includes a second stepped surface 3b87 exposed in the second annular accommodating groove 3b85. In the illustrated embodiment of the present disclosure, the second stepped surface 3b87 includes a third bottom surface 3b871, a fourth bottom surface 3b872 lower than the third bottom surface 3b871, and a second connecting surface 3b873 connecting the third bottom surface 3b871 and the fourth bottom surface 3b872.

The third mating sealing ring 3b6 is sleeved on the second annular inner wall portion 3b83 and located at a bottom of the second annular inner wall portion 3b83, with its bottom surface abutting against the third bottom surface 3b871. A cross-sectional shape of the third mating sealing ring 3b6 may be star-shaped or other shapes. In the description of the present disclosure, the star-shaped cross-section of the third mating sealing ring 3b6 means that the cross-section of the third mating sealing ring 3b6 includes a third base portion 3b61, and a plurality of third abutting protrusions 3b62 integrally extending from and protruding from the third base portion 3b61, with the plurality of third abutting protrusions 3b62 distributed circumferentially around the third base portion 3b61. In one embodiment of the present disclosure, the third base portion 3b61 is substantially rectangular, and the plurality of third abutting protrusions 3b62 are uniformly distributed circumferentially around the third base portion 3b61. The third abutting protrusions 3b62 are configured to abut against corresponding wall surfaces to achieve sealing. In the illustrated embodiment of the present disclosure, four third abutting protrusions 3b62 are provided. Of course, it is understandable to those skilled in the art that the number of the third abutting protrusions 3b62 can be flexibly adjusted as needed.

The fourth mating sealing ring 3b7 is sleeved on the second connecting surface 3b873 and located at a bottom of the second annular accommodating groove 3b85, with its bottom surface abutting against the fourth bottom surface 3b872. The cross-sectional shape of the fourth mating sealing ring 3b7 may be star-shaped, rectangular, or other shapes. In the description of the present disclosure, the star-shaped cross-section of the fourth mating sealing ring 3b7 means that the cross-section of the fourth mating sealing ring 3b7 includes a fourth base portion 3b71, and a plurality of fourth abutting protrusions 3b72 integrally extending from and protruding from the fourth base portion 3b71, with the plurality of fourth abutting protrusions 3b72 distributed circumferentially around the fourth base portion 3b71. In one embodiment of the present disclosure, the fourth base portion 3b71 is substantially rectangular, and the plurality of fourth abutting protrusions 3b72 are uniformly distributed circumferentially around the fourth base portion 3b71. The fourth abutting protrusions 3b72 are configured to abut against corresponding wall surfaces to achieve sealing. In the illustrated embodiment of the present disclosure, four fourth abutting protrusions 3b72 are provided. Of course, it is understandable to those skilled in the art that the number of the fourth abutting protrusions 3b72 can be flexibly adjusted as needed. In one embodiment of the present disclosure, the fourth mating sealing ring 3b7 is a regular annular shape. In another embodiment of the present disclosure, the fourth mating sealing ring 3b7 is an irregular annular shape, with a plurality of outwardly protruding protrusions (not shown) provided on the fourth mating sealing ring 3b7, and the plurality of protrusions are uniformly distributed circumferentially on the fourth mating sealing ring 3b7.

The second adapter sleeve 3b4 is accommodated in the second assembly hole 1b143. In one embodiment of the present disclosure, the second adapter sleeve 3b4 is made of metal (for example, copper). The second adapter sleeve 3b4 includes a third cylindrical portion 3b41, a fourth cylindrical portion 3b42, a second abutting surface 3b43 connecting the third cylindrical portion 3b41 and the fourth cylindrical portion 3b42, and a second mounting through-hole 3b44 extending through the third cylindrical portion 3b41 and the fourth cylindrical portion 3b42 along the second direction A2-A2. In the illustrated embodiment of the present disclosure, a diameter of the third cylindrical portion 3b41 is greater than a diameter of the fourth cylindrical portion 3b42. The third cylindrical portion 3b41 is accommodated in the third cylindrical hole 1b1431, the fourth cylindrical portion 3b42 is accommodated in the fourth cylindrical hole 1b1432, and the second abutting surface 3b43 abuts against the second stepped surface 1b1433. In the illustrated embodiment of the present disclosure, the fourth cylindrical portion 3b42 is provided with a fourth exposed surface 3b421 exposed to the second mating protrusion 1b14. The fourth exposed surface 3b421 contacts the second exposed surface 3a221 to improve protective performance.

Referring to FIG. 41 to FIG. 45, the first conductive terminal module 4b includes a first conductive terminal 4b1, a first insulating sleeve 4b2 sleeved on the first conductive terminal 4b1, a first sealing sleeve 4b3 sleeved on the first insulating sleeve 4b2, and a first press-fit nut 4b4 fixed to the first conductive terminal 4b1. The first sealing sleeve 4b3 is accommodated in the first installation cavity 1b221 of the first installation frame portion 1b22, and the first sealing sleeve 4b3 abuts against the first annular inner wall surface 1b222 to achieve sealing. The first press-fit nut 4b4 is configured to be electrically connected (for example, soldered or welded) to a circuit board (not shown).

The first conductive terminal 4b1 includes a first end portion 4b11, a first tail portion 4b12 disposed opposite to the first end portion 4b11, and a first intermediate portion 4b13 connecting the first end portion 4b11 and the first tail portion 4b12. The first end portion 4b11 defines a first through-hole 4b110 extending through the first end portion 4b11 along the second direction A2-A2. The first insulating sleeve 4b2 is sleeved on the first intermediate portion 4b13. In one embodiment of the present disclosure, the first conductive terminal 4b1 is flat-shaped and made of copper.

Similarly, the second conductive terminal module 5b includes a second conductive terminal 5b1, a second insulating sleeve 5b2 sleeved on the second conductive terminal 5b1, a second sealing sleeve 5b3 sleeved on the second insulating sleeve 5b2, and a second press-fit nut 5b4 fixed to the second conductive terminal 5b1. The second sealing sleeve 5b3 is accommodated in the second installation cavity 1b231 of the second installation frame portion 1b23, and the second sealing sleeve 5b3 abuts against the second annular inner wall surface 1b232 to achieve sealing. The second press-fit nut 5b4 is configured to be electrically connected (for example, soldered or welded) to the circuit board.

The second conductive terminal 5b1 includes a second end portion 5b11, a second tail portion 5b12 disposed opposite to the second end portion 5b11, and a second intermediate portion 5b13 connecting the second end portion 5b11 and the second tail portion 5b12. The second end portion 5b11 is provided with a second through-hole 5b110 extending through the second end portion 5b11 along the second direction A2-A2. The second insulating sleeve 5b2 is sleeved on the second intermediate portion 5b13. In one embodiment of the present disclosure, the second conductive terminal 5b1 is flat-shaped and made of copper.

In one assembly method of the present disclosure, the first adapter sleeve 2b4 is installed in the first mating protrusion 1b13. Then, the first conductive terminal module 4b is inserted into the second housing 1b from the first installation frame portion 1b22. Then, the first retaining sleeve 2b5 is fixed in the first mounting space 1b161 of the first mounting protrusion 1b16. Then, the first elastic washer 2b2 and the first flat washer 2b3 are sequentially sleeved on the first assembly portion 2b12. Then, the first mating terminal 2b1 is installed in the second housing 1b, and the first mating portion 2b13 is passed through the first through-hole 4b110 of the first conductive terminal 4b1 and the first mounting through-hole 2b44 of the first adapter sleeve 2b4, and the first mating portion 2b13 extends out of the first mounting through-hole 2b44. Then, the first mating sealing ring 2b6 is sleeved on the first annular inner wall portion 2b83, and the second mating sealing ring 2b7 is sleeved on the first connecting surface 2b873. Then, the first rotating cover 2b8 is snapped onto the first mating protrusion 1b13. At this time, the first force-applying protrusion 2b84 is inserted into the first engagement hole 2b15. In the illustrated embodiment of the present disclosure, the first rotating cover 2b8 is movable up and down relative to the first mating protrusion 1b13 along the second direction A2-A2.

During use, an external tool is used to rotate the first rotating cover 2b8. For example, by inserting the external tool into the first spline slot 2b810 of the first rotating cover 2b8 and applying force to rotate the first rotating cover 2b8, the first rotating cover 2b8 drives the first mating terminal 2b1 to further screw into the first terminal mating hole 2a23 while rotating. At this time, a distance between the first rotating cover 2b8 and the first mating protrusion 1b13 along the second direction A2-A2 is shortened. The first mating sealing ring 2b6 is axially sealed between the first retaining sleeve 2b5 and the first bottom surface 2b871, and the first mating sealing ring 2b6 is radially sealed between the first annular inner wall portion 2b83 and the inner wall surface of the first mounting protrusion 1b16. The second mating sealing ring 2b7 is axially sealed between the second bottom surface 2b872 and the first edge portion 1b162 of the first mounting protrusion 1b16. In the illustrated embodiment of the present disclosure, the first mating portion 2b13 extends at least partially into the first recessed space 1a131 of the first raised portion 1a13.

The assembly methods of the second terminal module 3b and the second conductive terminal module 5b of the mating connector 200 are the same as those of the first terminal module 2b and the first conductive terminal module 4b, respectively, and will not be repeated here.

Referring to FIG. 24 to FIG. 30, the locking device 6b includes a slider 6b1, a first terminal 6b2 secured to the slider 6b1, and a first sealing ring 6b3 sleeved on the slider 6b1.

In the illustrated embodiment of the present disclosure, the slider 6b1 is made of insulating material and includes a first main body 6b11, a base 6b12 protruding upwardly from the first main body 6b11 along the second direction A2-A2, at least one limiting protrusion 6b13 protruding outward from the base 6b12, a first tab 6b14 protruding from one side of the first main body 6b11, a second tab 6b15 protruding from another side of the first main body 6b11, an extension block 6b16 protruding downwardly from the first main body 6b11 along the second direction A2-A2, an unlocking portion 6b17 extending and protruding from the first main body 6b11 along the first direction A1-A1, an elastic arm 6b18 connected to the unlocking portion 6b17 along the first direction A1-A1, and a first insertion portion 6b19 integrally extending from the first main body 6b11 along the first direction A1-A1. The first insertion portion 6b19 is located above the elastic arm 6b18 along the second direction A2-A2.

In the illustrated embodiment of the present disclosure, the first tab 6b14 is provided with an inclined first locking surface 6b141. The second tab 6b15 is provided with an inclined second locking surface 6b151. In the illustrated embodiment of the present disclosure, the inclination directions of the first locking surface 6b141 and the second locking surface 6b151 are different. The first locking surface 6b141 and the second locking surface 6b151 form an acute angle. When the first rotating cover 2b8 and the second rotating cover 3b8 are at an appropriate height, the first tab 6b14 engages with the first slot 2b821 of the first rotating cover 2b8, and the second tab 6b15 engages with the second locking groove 3b821 of the second rotating cover 3b8 (as shown in FIG. 28).

The extension block 6b16 is provided with a first arc-shaped notch 6b161 and a second arc-shaped notch 6b162 on two sides thereof, respectively. The first arc-shaped notch 6b161 matches the arc-shaped side edge of the first rotating cover 2b8, and the second arc-shaped notch 6b162 matches the arc-shaped side edge of the second rotating cover 3b8. When the first rotating cover 2b8 is not fully rotated in place, the first rotating cover 2b8 is at least partially located in the first arc-shaped notch 6b161. At this time, the first rotating cover 2b8 will block the extension block 6b16, so the slider 6b1 cannot move along the first direction A1-A1 to bring the elastic arm 6b18 to the locking position, serving as a fool-proof function. Similarly, when the second rotating cover 3b8 is not fully rotated in place, the second rotating cover 3b8 is at least partially located in the second arc-shaped notch 6b162. At this time, the second rotating cover 3b8 will block the extension block 6b16, so the slider 6b1 cannot move along the first direction A1-A1 to bring the elastic arm 6b18 to the locking position, serving as a fool-proof function and improving safety.

Referring to FIG. 24, it is understandable to those skilled in the art that when the first rotating cover 2b8 and/or the second rotating cover 3b8 are not fully rotated in place, the first rotating cover 2b8 and/or the second rotating cover 3b8 can block the extension block 6b16, so the slider 6b1 cannot be pushed along the first direction A1-A1. It is understandable to those skilled in the art that when the first rotating cover 2b8 and the second rotating cover 3b8 are not fully rotated in place, it means that the first mating terminal 2b1 and the second mating terminal 3b1 are not fully inserted, and there may be a problem of poor contact. At this time, since the slider 6b1 cannot be pushed along the first direction A1-A1, the likelihood of mistaking poor contact for reliable connection is reduced.

Referring to FIG. 25, it is understandable to those skilled in the art that when the first rotating cover 2b8 is fully rotated in place, the first rotating cover 2b8 completely disengages from the first arc-shaped notch 6b161 along the second direction A2-A2. When the second rotating cover 3b8 is fully rotated in place, the second rotating cover 3b8 completely disengages from the second arc-shaped notch 6b162 along the second direction A2-A2. At this time, the first rotating cover 2b8 and the second rotating cover 3b8 no longer block the extension block 6b16, so the slider 6b1 can be pushed along the first direction A1-A1 to bring the elastic arm 6b18 to the locking position. Meanwhile, the first tab 6b14 engages with the first slot 2b821 of the first rotating cover 2b8, and the second tab 6b15 engages with the second locking groove 3b821 of the second rotating cover 3b8 to prevent the first rotating cover 2b8 and the second rotating cover 3b8 from falling off.

The base 6b12 is inserted into the first installation guide groove 1b1531, the receiving slot 1b155 and the second installation guide groove 1b1541. The limiting protrusion 6b13 abuts against the first stop surface 1b1532 or the second stopping surface 1b1542 to prevent the slider 6b1 from falling off the second housing 1b.

The elastic arm 6b18 is cantilevered and provided with a hook portion 6b181 at a free end thereof. The hook portion 6b181 is provided with a guiding inclined surface 6b1811 and a locking surface 6b1812. The elastic arm 6b18 can elastically deform about a pivot point. When the elastic arm 6b18 moves from a non-locking position to a locking position, the guiding inclined surface 6b1811 mates with the protrusion 1b252. When the elastic arm 6b18 reaches the locking position, the locking surface 6b1812 engages with the protrusion 1b252 to achieve locking.

The unlocking portion 6b17 is used to apply an unlocking force, causing the elastic arm 6b18 to elastically deform around the pivot point to achieve unlocking.

The first terminal 6b2 is assembled and fixed in the slider 6b1. The first terminal 6b2 includes a first pin portion 6b21 and a second pin portion 6b22. The first insertion portion 6b19 is provided with a first positioning groove 6b191 on an outer side thereof, and the first sealing ring 6b3 is retained in the first positioning groove 6b191. The first insertion portion 6b19 is further provided with a fixing groove 6b192 extending through the first insertion portion 6b19 along the first direction A1-A1, and the first terminal 6b2 is fixed in the fixing groove 6b192. Both the first pin portion 6b21 and the second pin portion 6b22 extend and protrude beyond the first insertion portion 6b19 along the first direction A1-A1.

Referring to FIG. 31 to FIG. 39, the installation assembly 7b includes an insulating block 7b1, a second terminal 7b2 installed in the insulating block 7b1, a third terminal 7b3 installed in the insulating block 7b1, a first sealing plug 7b4 cooperating with the second terminal 7b2, a second sealing plug 7b5 mating with the third terminal 7b3, a second sealing ring 7b6 sleeved on the insulating block 7b1, and a pin 7b7 installed on the insulating block 7b1. Of course, it is understandable to those skilled in the art that in other embodiments of the present disclosure, for applications with lower waterproofing requirements, the installation assembly 7b may omit one or more of the first sealing plug 7b4, the second sealing plug 7b5, and the second sealing ring 7b6.

The insulating block 7b1 includes a second main body 7b11, a second insertion portion 7b12, a transition portion 7b13 connecting the second main body 7b11 and the second insertion portion 7b12 along the first direction A1-A1, and a first receiving hole 7b14 and a second receiving hole 7b15 which extend through the insulating block 7b1 along the first direction A1-A1.

In the illustrated embodiment of the present disclosure, the second main body 7b11 is provided with a first locking block 7b111 protruding upwardly along the second direction A2-A2, a second locking block 7b112 protruding downwardly along the second direction A2-A2, and a limiting protrusion 7b113 protruding upwardly along the second direction A2-A2. The limiting protrusion 7b113 and the first locking block 7b111 are located on a same side of the second main body 7b11. The limiting protrusion 7b113 and the first locking block 7b111 are spaced apart along the first direction A1-A1. Besides, the second main body 7b11 is further provided with a conical guiding surface 7b114 disposed adjacent to the transition portion 7b13. In the illustrated embodiment of the present disclosure, an upper concept of the first locking block 7b111 and the second locking block 7b112 is a locking block 7b115.

The transition portion 7b13 defines a second positioning groove 7b131 on an outer side thereof, and the second sealing ring 7b6 is retained in the second positioning groove 7b131.

The second insertion portion 7b12 includes a first wall portion 7b121 (for example, a side wall portion) and a second wall portion 7b122 (for example, a bottom wall portion) connected to the first wall portion 7b121. The first wall portion 7b121 defines an installation opening 7b1211 which extends through the first wall portion 7b121 and communicates with the first receiving hole 7b14 and the second receiving hole 7b15. In addition, the first wall portion 7b121 is further provided with a guiding block 7b1212 protruding into the installation opening 7b1211, and a retaining recess 7b1213 located at an upper end of the guiding block 7b1212 and communicating with the installation opening 7b1211. The guiding block 7b1212 is provided with a guiding inclined surface 7b1214. The second wall portion 7b122 defines a receiving recess 7b1221 communicating with the installation opening 7b1211.

The pin 7b7 includes a side plate 7b71 installed in the installation opening 7b1211, a bottom plate 7b72 connected to the side plate 7b71, and a first abutting protrusion 7b73 and a second abutting protrusion 7b74 protruding inwardly from the inner wall surface of the side plate 7b71. The first abutting protrusion 7b73 and the second abutting protrusion 7b74 are spaced apart along the second direction A2-A2. The first abutting protrusion 7b73 and the second abutting protrusion 7b74 protrude beyond the installation opening 7b1211 into the first receiving hole 7b14 and the second receiving hole 7b15, respectively. The side plate 7b71 is provided with a locking hook 7b711 protruding along the first direction A1-A1.

The second terminal 7b2 includes a first cable connection portion 7b21, a first limiting portion 7b22 connected to one end of the first cable connection portion 7b21, and a first engagement portion 7b23 connected to another end of the first cable connection portion 7b21. The first limiting portion 7b22 is radially enlarged compared to the first cable connection portion 7b21 to limit the first sealing plug 7b4 and prevent it from falling off the second terminal 7b2. The first engagement portion 7b23 is generally frame-shaped and defines a first insertion hole 7b231 for accommodating the first pin portion 6b21.

Similarly, the third terminal 7b3 includes a second cable connection portion 7b31, a second limiting portion 7b32 connected to one end of the second cable connection portion 7b31, and a second engagement portion 7b33 connected to another end of the second cable connection portion 7b31. The second limiting portion 7b32 is radially enlarged compared to the second cable connection portion 7b31 to limit the second sealing plug 7b5 and prevent it from falling off the third terminal 7b3. The second engagement portion 7b33 is generally frame-shaped and defines a second insertion hole 7b331 for accommodating the second pin portion 6b22.

When assembling the installation assembly 7b, firstly, the first sealing plug 7b4 and the second sealing plug 7b5 are sleeved on a first low-voltage cable (not shown) and a second low-voltage cable (not shown), respectively. Then, the first low-voltage cable (not shown) and the second low-voltage cable (not shown) are crimped and connected to the first cable connection portion 7b21 and the second cable connection portion 7b31, respectively. Then, the first sealing plug 7b4 and the second sealing plug 7b5 are sleeved on the first cable connection portion 7b21 and the second cable connection portion 7b31, respectively. At this time, two ends of the first sealing plug 7b4 are limited by the first limiting portion 7b22 and the first mating portion 7b23, and two ends of the second sealing plug 7b5 are limited by the second limiting portion 7b32 and the second engagement portion 7b33. Then, the second sealing ring 7b6 is retained in the second positioning groove 7b131. Then, the pin 7b7 is preliminarily installed in the installation opening 7b1211. At this stage, the locking hook 7b711 is not engaged with the retaining recess 7b1213. Then, the second terminal 7b2 and the third terminal 7b3 are inserted and fixed into the first receiving hole 7b14 and the second receiving hole 7b15, respectively. The first sealing plug 7b4 and the second sealing plug 7b5 seal the second terminal 7b2 and the third terminal 7b3, respectively. Then, the pin 7b7 is finally installed in the installation opening 7b1211 along the second direction A2-A2. At this point, the locking hook 7b711 passes over the guiding block 7b1212 and engages with the retaining recess 7b1213, and the bottom plate 7b72 is accommodated in the receiving recess 7b1221. Finally, the installation assembly 7b is inserted into the first assembly space 1b242 along the first direction A1-A1. The second insertion portion 7b12 is at least partially inserted into the second installation protrusion portion 1b25, the second sealing ring 7b6 seals the installation assembly 7b, the conical guiding surface 7b114 fits with the guiding conical surface 1b2411, the limiting wall surface 1b2412 blocks the limiting protrusion 7b113, and the first locking block 7b111 and the second locking block 7b112 engage with the locking hole 1b243 to prevent the installation assembly 7b from falling off.

When the electrical connector 100 is mated with the mating connector 200, under the guidance of the second conical surface 1a311, the first inclined surface 7a212, and the second inclined surface 7a312 of the electrical connector 100, the guiding conical surface 1b180 of the mating connector 200 mates with the second conical surface 1a311, the first mating conical surface 1b1311 of the mating connector 200 mates with the first inclined surface 7a212, and the second mating conical surface 1b1411 of the mating connector 200 mates with the second inclined surface 7a312. As a result, the second housing 1b of the mating connector 200 can achieve blind mating with the first housing 1a of the electrical connector 100, reducing the issue of the electrical connector 100 and the mating connector 200 being unable to mate due to accumulated tolerances. After the electrical connector 100 and the mating connector 200 are fully inserted along the second direction A2-A2, a tool is inserted into the first spline slot 2b810 of the first rotating cover 2b8 and the second spline slot 3b810 of the second rotating cover 3b8 to rotate the first rotating cover 2b8 and the second rotating cover 3b8. The first mating terminal 2b1 and the second mating terminal 3b1 are directly or indirectly driven by the first rotating cover 2b8 and the second rotating cover 3b8, respectively, to rotate while moving along the second direction A2-A2, ultimately causing the first mating portion 2b13 and the second mating portion 3b13 to screw into the first terminal mating hole 2a23 and the second terminal mating hole 3a23, respectively. When the electrical connector 100 is equipped with the first thread sleeve 2a3 and the second thread sleeve 3a3, the first mating thread 2b131 of the first mating portion 2b13 and the second mating thread 3b131 of the second mating portion 3b13 threadedly engage with the first thread sleeve 2a3 and the second thread sleeve 3a3, respectively, to improve mating reliability.

When the first rotating cover 2b8 and the second rotating cover 3b8 are fully rotated in place, the locking device 6b is movable along the first direction A1-A1 to bring the elastic arm 6b18 to the locking position, where it engages with the protrusion 1b252. At this time, the first pin portion 6b21 and the second pin portion 6b22 of the first terminal 6b2 are inserted into the second terminal 7b2 and the third terminal 7b3, respectively, to achieve electrical conduction.

Compared to related technologies, the present disclosure eliminates the need to disassemble the mating connector 200 when mating the electrical connector 100 with the mating connector 200, reducing the risk of electric shock and improving mating convenience. By rotating the first rotating cover 2b8 and the second rotating cover 3b8, the first mating terminal 2b1 and the second mating terminal 3b1 can achieve electrical conduction with the first cable assembly 2a and the second cable assembly 3a, respectively. In the illustrated embodiment of the present disclosure, the conductive components of the mating connector 200 include only two screws (i.e., the first mating terminal 2b1 and the second mating terminal 3b1), thereby reducing the number of parts and improving mating convenience.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. A mating connector, comprising:
a housing comprising a main body portion and an installation portion, the installation portion comprising a protrusion;
a mating terminal at least partially disposed in the main body portion, the mating terminal comprising a mating portion extending in a direction, the direction being perpendicular to another direction;
a locking device slidably installed on the main body portion along the another direction, the locking device comprising a slider having an elastic arm, the elastic arm locking with the protrusion along the another direction; and
a rotating cover installed on the main body portion, the rotating cover driving the mating terminal to move along the direction;
wherein the rotating cover defines a slot, and the slider is provided with a tab mating with the slot.

2. The mating connector according to claim 1, wherein the elastic arm comprises a hook portion disposed at a free end thereof, and the hook portion locks with the protrusion along the another direction.

3. The mating connector according to claim 2, wherein the hook portion comprises a guiding inclined surface and a locking surface, the guiding inclined surface guides the elastic arm over the protrusion, and the locking surface locks with the protrusion.

4. The mating connector according to claim 1, wherein the rotating cover directly or indirectly drives the mating terminal to move along the direction through rotation.

5. The mating connector according to claim 4, wherein the mating connector has a first state where the rotating cover is not fully rotated, preventing the locking device from locking with the protrusion along the another direction.

6. The mating connector according to claim 4, wherein the mating connector has a second state where the rotating cover is fully rotated, allowing the locking device to move along the another direction to lock with the protrusion, and the tab is inserted into the slot.

7. The mating connector according to claim 1, wherein the tab comprises an inclined locking surface mating with the slot.

8. The mating connector according to claim 1, wherein the slider comprises a main body, a base protruding from the main body along the direction, and at least one limiting protrusion protruding outward beyond the base;
the tab protrudes beyond a side of the main body;
the main body portion comprises a first side wall, a second side wall, and a receiving slot disposed between the first side wall and the second side wall; the first side wall comprises a first installation guide groove communicating with the receiving slot and a stop surface disposed at one end of the first installation guide groove; the second side wall comprises a second installation guide groove communicating with the receiving slot; the base is at least partially inserted into the first installation guide groove, the receiving slot and the second installation guide groove;
the stop surface mates with the limiting protrusion to prevent the locking device from disengaging from the main body portion.

9. The mating connector according to claim 8, wherein the slider comprises an unlocking portion protruding from the main body along the another direction; the elastic arm is connected to the unlocking portion along the another direction; the unlocking portion disengages the elastic arm from the protrusion under an external force.

10. The mating connector according to claim 8, wherein the locking device comprises a first terminal secured to the slider;
the slider comprises an insertion portion integrally extending from the main body, and the insertion portion is located on one side of the elastic arm along the direction;
the insertion portion comprises a fixing groove extending through the insertion portion along the another direction;
the first terminal is secured in the fixing groove and comprises a first pin portion and a second pin portion; the first pin portion and the second pin portion both extend beyond the insertion portion along the another direction.

11. The mating connector according to claim 10, wherein the insertion portion comprises a positioning groove on an outer side thereof, and the locking device comprises a first sealing ring sleeved on the insertion portion and retained in the positioning groove.

12. The mating connector according to claim 10, wherein the installation portion comprises a second installation extension having a second annular wall portion; the protrusion protrudes beyond the second annular wall portion along the direction;
the insertion portion is at least partially inserted into the second annular wall portion.

13. The mating connector according to claim 12, wherein the installation portion comprises a first installation extension; the first installation extension comprises a first annular wall portion and an assembly space extending through the first installation extension along the another direction;
the mating connector comprises an installation assembly at least partially installed in the assembly space; the installation assembly comprises an insulating block, a second terminal disposed in the insulating block, and a third terminal disposed in the insulating block; wherein the first pin portion and the second pin portion of the first terminal are in contact with the second terminal and the third terminal, respectively.

14. The mating connector according to claim 13, wherein the insulating block defines a first receiving hole and a second receiving hole extending through the insulating block along the another direction;
the second terminal is received in the first receiving hole and comprises a first cable connection portion, a first limiting portion connected to one end of the first cable connection portion, and a first engagement portion connected to another end of the first cable connection portion;
the third terminal is received in the second receiving hole and comprises a second cable connection portion, a second limiting portion connected to one end of the second cable connection portion, and a second engagement portion connected to another end of the second cable connection portion.

15. The mating connector according to claim 14, wherein the installation assembly comprises a first sealing plug sleeved on the first cable connection portion and retained by the first limiting portion, and a second sealing plug sleeved on the second cable connection portion and retained by the second limiting portion; the first sealing plug and the second sealing plug seal the second terminal and the third terminal in the first receiving hole and the second receiving hole, respectively.

16. The mating connector according to claim 14, wherein the installation assembly comprises a pin installed on the insulating block; the pin has a first abutting protrusion and a second abutting protrusion; the first abutting protrusion abuts against the first engagement portion, and the second abutting protrusion abuts against the second engagement portion.

17. The mating connector according to claim 16, wherein the pin comprises a side plate;
the insulating block comprises an installation opening, a guiding block protruding into the installation opening, and a retaining recess disposed at one end of the guiding block and communicating with the installation opening; the side plate is received in the installation opening and comprises a locking hook retained in the retaining recess.

18. The mating connector according to claim 13, wherein the first annular wall portion comprises at least one locking hole communicating with the assembly space, and the insulating block comprises at least one locking block locked in the locking hole.

19. The mating connector according to claim 1, wherein the rotating cover comprises a cover body, an annular outer wall portion protruding beyond the cover body, an annular inner wall portion protruding beyond the cover body, and an annular accommodating groove disposed between the annular inner wall portion and the annular outer wall portion;
the mating connector comprises a first mating sealing ring and a second mating sealing ring which are disposed in the annular accommodating groove, the first mating sealing ring and the second mating sealing ring are spaced apart along the direction.

20. The mating connector according to claim 19, wherein the first mating sealing ring has a cross-section comprising a first base portion and a plurality of first abutting protrusions extending from the first base portion and distributed circumferentially;
the second mating sealing ring has a rectangular cross-section, or comprises a second base portion and a plurality of second abutting protrusions extending from the second base portion and distributed circumferentially.

21. The mating connector according to claim 19, wherein the cover body comprises a first stepped surface exposed to the first annular accommodating groove; the first stepped surface has a first bottom surface, a second bottom surface disposed lower than the first bottom surface, and a first connecting surface connecting the first bottom surface and the second bottom surface;
the first mating sealing ring is sleeved on the first annular inner wall portion; and
the second mating sealing ring is sleeved on the first connecting surface.

22. The mating connector according to claim 1, wherein the mating terminal comprises a first abutting portion and a first assembly portion connected to the first abutting portion along the direction; the first mating portion is connected to the first assembly portion along the direction;
the mating connector further comprises a first elastic washer sleeved on the first assembly portion and a first flat washer sleeved on the first assembly portion; the first elastic washer is disposed between the first abutting portion and the first flat washer along the direction.
